(19) United States
(12) Patent Application Publication
(10) Pub. No.: US 2023/0070066 A1
(43) Pub. Date: Mar. 9, 2023

(54) NONFLAMMABLE REFRIGERANTS HAVING LOW GWP, AND SYSTEMS FOR AND METHODS OF PROVIDING REFRIGERATION

(71) Applicant: HONEYWELL INTERNATIONAL INC., Charlotte, NC (US)

(72) Inventors: Nilesh Purohit, Charlotte, NC (US); Gustavo Pottker, Charlotte, NC (US); Ankit Sethi, Charlotte, NC (US); Samuel Yana Motta, Charlotte, NC (US)

(73) Assignee: HONEYWELL INTERNATIONAL INC., Charlotte, NC (US)

(21) Appl. No.: 17/872,421

(22) Filed: Jul. 25, 2022

Related U.S. Application Data
(60) Provisional application No. 63/235,818, filed on Aug. 23, 2021.

(51) Int. Cl. C09K 5/04

(52) U.S. Cl. CPC C09K 5/045; C09K 2205/126; C09K 2205/43; C09K 2205/22

(57) ABSTRACT

The present invention relates to a refrigerant composition comprising 75-80% by weight of HFO-1234ze(E), 6% to not greater than 12% by weight of HFC-134a and from 11% to about 17% by weight of HFO1336mzz(E), and to the use of the refrigerant in a heat exchange systems, including electronic cooling, low and medium temperature refrigeration and to the use of such compositions as a replacement of the refrigerant R-410A for heating and cooling applications.

### CROSS REFERENCE TO RELATED APPLICATIONS

This application claims the priority benefit of U.S. Provisional Application No. 63/235,818, filed Aug. 23, 2021, which is incorporated herein by reference in its entirety.

### FIELD OF THE INVENTION

This invention relates to high efficiency, high capacity, low-global warming potential (“low GWP”) compositions, methods, and systems having utility in heat transfer applications, with particular benefit in medium and low temperature refrigeration systems, cascade refrigeration systems, transport refrigeration systems, and heat pumps, and in particular aspects to refrigerant compositions for replacement of the refrigerants R-22, R404A, R407F, R448A, R449A, R-134a. R404A and R410A for various heating and cooling applications, including for medium and low temperature refrigeration systems, cascade refrigeration systems, transport refrigeration systems, and heat pumps.

### BACKGROUND

Certain single-component fluorocarbons, including chlorofluorocarbons (“CFCs”), hydrochlorofluorocarbons (“HCFCs”), and hydrofluorolefins (“HFOs”), have been used in many heat transfer applications. One advantage that single component fluids have as refrigerants is that for a given pressure, the boiling point is constant. This is highly desirable because it permits the refrigeration system or method to be designed with a refrigerant temperature along the evaporator that remains essentially constant during the evaporation processes, assuming little or no pressure drop as the refrigerant flows through the evaporator.

Prior to the present invention, those skilled in the art have utilized mainly single component refrigerants, such as HFC-134a, in many refrigeration applications and have avoided refrigerant blends because blends generally undergo a significant change in boiling point temperature upon evaporation, which has heretofore been perceived as a major obstacle to the ability to identify blends having the correct balance of properties to be useful in such systems. This change in boiling point temperature is generally reflected in the property of the blend known as the “glide” of the blend. In general, the larger the glide the greater the difference in boiling temperature which occurs in various pieces of refrigeration equipment. For many important applications, this parameter is considered critical for the success of the refrigerant and/or the refrigeration system in which it is used, with glide of less than 3° C. providing significant advantage in many important applications.

Another refrigerant characteristic which has become increasingly important in recent years, to the point of now being critical for many applications, is the environmental friendliness of the refrigerant. This environmental friendliness can be measured, at least in part, by the projected impact that release of the refrigerant into the atmosphere would have on global warming. This projected impact is frequently measured as the global warming potential (GWP) of the refrigerant, with refrigerants having a GWP being highly preferred and/or legally required for use in many applications.

Flammability is another important consideration for refrigerants used in applications. Currently, it is most preferred for a refrigerant to a nonflammable substance as classified by ASHRAE as Class 1. A second preferred class of nonflammability is the classification by ASHRAE of Class 2L. Applicants and others in the field have come to recognize that it is very difficult to develop new refrigerants that are at the same time environmentally friendly, preferably with a GWP of less than 150, have low glide, preferably less than 3° C., and are nonflammable, preferably having a classification of 2L or 1. Applicants have come to particularly appreciate that it is extremely difficult in many applications to identify a single-component fluid, much less a refrigerant that is a blend of components, that possesses the full set of properties that make it of particular advantage in applications of the type discussed herein. For example, in many important applications, it is necessary to identify a refrigerant that simultaneously: (1) has workable glide, e.g., a glide of less than about 3° C., and even more preferably below about 2.5° C.; (2) has low global warming potential (GWP) (i.e., less than about 150); (3) is non-flammable (i.e., is Class 1 according to ASHRE); (4) has low or no substantial toxicity; and (5) has heat transfer and other properties (such as chemical stability) that match the needs of the particular applications, especially in medium temperature heat transfer systems. While the use of single component refrigerants has been able in many cases to satisfy one or two of these items, those skilled in the art have found it difficult (if not impossible) to heretofore find a refrigerant (whether single component or otherwise) that can satisfy all five items, that is, each of items (1)-(5) is achieved. Here a low toxicity substance is classified as class “A” by ASHRAE Standard 34-2016. A substance which is non-flammable and low-toxicity would be classified as “A1” by ASHRAE Standard 34-2016.

Refrigerants based upon the use of multiple components to form a refrigerant blend have been proposed. For example, US 2016/0115362 (Rached), has described refrigerant compositions based upon (E)-1,1,1,4,4,4-hexafluorobut-2-ene (HFO-E-1336mzz) in combination with one or more other components, such as hydrocarbons hydrofluorocarbon's, ethers hydrofluorocarbon ethers and fluoroolefins. Included among the numerous possible blends described in this publication are blends comprising HFO-E-1336mzz, HFO-1234ze and HFC-134a. (See paragraphs [0197] and [0210]). Despite working extensively with these three components, blends proposed in Rached all fail to satisfy one or more of the important requirements described above. For example, paragraph [0197] includes blends that contain 10% or less of HFO-E-1336mzz, and while these blends may possess some desirable properties, in all cases the disclosed blends have been determined by applicants to be flammable. Paragraph [0210] of Rached discloses eighteen (18) different blends comprising these three components, but among all of these possible blends, only five of the disclosed blends are able to achieve a glide of less than 3° C., and none of the disclosed blends is able to simultaneously achieve a glide of less than 3° C. and a GWP of less than 150 since in all cases having a glide below 3° C., the amount of R-134a in the blend is 20% by weight or greater.

Notwithstanding the failure of the blends in Rached mentioned above, applicants have unexpectedly and advantageously found, as described in detail hereinafter, that certain refrigerants based on carefully selected amounts of the combination of HFO-E-1336mzz, HFO-1234ze and HFC-134a can at once achieve a refrigerant that has (1) a glide less than 3° C., and even more preferably 2.5° C. or less; (2) has a global warming potential (GWP), determined as described hereinafter, of less than 150); (3) is non-flammable (i.e., as used herein, is Class 1 according to ASHRAE); (4) has low or no substantial toxicity; and (5) has heat transfer and other properties (such as chemical stability) that match the needs of many important applications.

### SUMMARY OF THE INVENTION

Applicants have discovered refrigerant compositions, heat transfer compositions comprising the refrigerant, refrigeration methods and systems, which utilize one or more of the compositions of the present invention as a refrigerant.

Thus, the present invention includes refrigerants comprising HFO1336mzz(E), HFO-1234ze(E) and HFC-134a that have a GWP of less than about 150, are classified as A1 (non-flammable and low toxicity) by ASHRAE, and have an evaporator glide of less than 3° C. and even more preferably less than 2.5° C.

The present invention includes refrigerants consisting essentially of:

from about 75% to about 80% by weight of HFO-1234ze(E),
from 6% to less than 11% by weight of HFC-134a; and
from 11% to about 18% by weight of HFO-1336mzz(E). The refrigerant according to this paragraph is sometimes referred to herein for convenience as Refrigerant 1.

The present invention also includes refrigerants consisting essentially of:

from 75% to less than 79% by weight of HFO-1234ze(E),
from 6% to not greater than 10% by weight of HFC-134a; and
from 11% to 18% by weight of HFO-1336mzz(E). The refrigerant according to this paragraph is sometimes referred to herein for convenience as Refrigerant 2.

The present invention also includes refrigerants consisting essentially of:

from 73% to 78% by weight of HFO-1234ze(E),
from 8% to less than 11% by weight of HFC-134a; and
from 11% to about 16% by weight of HFO-1336mzz(E). The refrigerant according to this paragraph is sometimes referred to herein for convenience as Refrigerant 3.

The present invention also includes refrigerants consisting essentially of:

from 76% to less than 79% by weight of HFO-1234ze (E),
from 8% to not greater than 10% by weight of HFC-134a; and
from 11% to about 15% by weight of HFO-1336mzz (E). The refrigerant according to this paragraph is sometimes referred to herein for convenience as Refrigerant 4.

The present invention also includes refrigerants consisting essentially of:

from 75% to less than 79% by weight of HFO-1234ze (E),
from 8% to not greater than 10% by weight of HFC-134a; and
from 11% to about 14% by weight of HFO-1336mzz (E). The refrigerant according to this paragraph is sometimes referred to herein for convenience as Refrigerant 5.

The present invention also includes refrigerants consisting of:

from 75% to less than 79% by weight of HFO-1234ze (E),
from 8% to not greater than 11% by weight of HFC-134a; and
from 11% to about 15% by weight of HFO-1336mzz (E). The refrigerant according to this paragraph is sometimes referred to herein for convenience as Refrigerant 6.

The present invention also includes refrigerants consisting essentially of:

about 78% by weight of HFO-1234ze (E),
10%+2/−0.5% by weight of HFC-134a; and
about 12% by weight of HFO-1336mzz (E). The refrigerant according to this paragraph is sometimes referred to herein for convenience as Refrigerant 7.

The present invention also includes refrigerants consisting of:

about 78% by weight of HFO-1234ze (E),
10%+2/−0.5 by weight of HFC-134a; and
about 12% by weight of HFO-1336mzz (E). The refrigerant according to this paragraph is sometimes referred to herein for convenience as Refrigerant 8.

The present invention also includes refrigerants consisting essentially of:

from about 75% to about 80% by weight of HFO-1234ze (E),
from 6% to not greater than about 10% by weight of HFC-134a; and
from about 12% to 18% by weight of HFO-1336mzz (E), provided that the refrigerant has an evaporator glide of less than 3° C. and a GWP of less than 150. The refrigerant according to this paragraph is sometimes referred to herein for convenience as Refrigerant 9.

The present invention also includes refrigerants consisting essentially of:

from about 75% to about 80% by weight of HFO-1234ze (E),
from 6% to not greater than about 10% by weight of HFC-134a; and
from about 12% to about 17% by weight of HFO-1336mzz (E), provided that the refrigerant has an evaporator glide of less than 3° C., a GWP of less than 150 and is a Class 1 non-flammable refrigerant. The refrigerant according to this paragraph is sometimes referred to herein for convenience as Refrigerant 10.

The present invention also includes refrigerants consisting essentially of:

from about 75% to about 80% by weight of HFO-1234ze (E),
from 6% to not greater than about 10% by weight of HFC-134a; and
from about 12% to about 15% by weight of HFO-1336mzz (E), provided that the refrigerant has an evaporator glide of not greater than 2.5° C. and a GWP of less than 150. The refrigerant according to this paragraph is sometimes referred to herein for convenience as Refrigerant 11.

The present invention also includes refrigerants consisting essentially of:

from about 75% to about 80% by weight of HFO-1234ze (E),
from 6% to not greater than about 10% by weight of HFC-134a; and
from about 12% to about 15% by weight of HFO-1336mzz (E), provided that the refrigerant has an evaporator glide of not greater than 2.5° C., a GWP of less than 150 and is a Class 1 non-flammable refrigerant. The refrigerant according to this paragraph is sometimes referred to herein for convenience as Refrigerant 12.

The present invention also includes refrigerants consisting essentially of:

78%+0.5%/−2% by weight of HFO-1234ze (E),
10%+2%/−0.5% by weight of HFC-134a; and
12%+2%/−0.5% by weight of HFO-1336mzz (E). The refrigerant according to this paragraph is sometimes referred to herein for convenience as Refrigerant 13.

The present invention also includes refrigerants consisting of:

78%+0.5%/−2% by weight of HFO-1234ze (E),
10%+2%/−0.5% by weight of HFC-134a; and
12%+2%/−0.5% by weight of HFO-1336mzz (E). The refrigerant according to this paragraph is sometimes referred to herein for convenience as Refrigerant 14.

### BRIEF DESCRIPTION OF THE DRAWINGS

FIG. 1 is a schematic representation of an exemplary heat transfer system useful in air conditioning, low temperature refrigeration and medium temperature refrigeration.

FIG. 2 is a schematic representation of an exemplary heat transfer system useful in low and medium temperature refrigeration and which includes a vapor injector.

FIG. 3 is a schematic representation of an exemplary heat transfer system useful in low and medium temperature refrigeration and which includes a liquid injector.

FIG. 4 is a schematic representation of an exemplary heat transfer system useful in low and medium temperature refrigeration and which includes a suction line/liquid line heat exchanger.

FIG. 5 is a schematic representation of an exemplary heat transfer system useful in low and medium temperature refrigeration and which includes a vapor injector and an oil separator.

### DESCRIPTION OF PREFERRED COMPOSITIONS

### Definitions

The term “capacity” is the amount of cooling provided, in BTUs/hr, by the refrigerant in the refrigeration system. This is experimentally determined by multiplying the change in enthalpy in BTU/lb, of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. The time period usually used for GWP is 100 years. GWP provides a common measure, which allows analysts to add up emission estimates of different gases. See http://www.protocolodemontreal.org.br/site/images/publicacoes/setor_manufatura_equpame ntos_refrigeracao_arcondicionado/Como_calcular_el_Potential_de_Calentamiento_Atmosfer ico_en_las_mezclas_de_refrigerantes.pdf

The term “Occupational Exposure Limit (OEL)” is determined in accordance with ASHRAE Standard 34-2016 Designation and Safety Classification of Refrigerants.

The phrase “acceptable toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and low-toxicity would be classified as “A1” by ASHRAE Standard 34-2016 Designation and Safety Classification of Refrigerants and described in Appendix B1 to ASHRAE Standard 34-2016 (as each standard exists as of the filing date of this application).

The term “mass flow rate” is the mass of refrigerant passing through a conduit per unit of time.

The term “non-flammable” refers to compounds or compositions which are determined to be nonflammable as determined in accordance with ASTM Standard E-681-2009 Standard Test Method for Concentration Limits of Flammability of Chemicals (Vapors and Gases) at conditions described in ASHRAE Standard 34-2016 Designation and Safety Classification of Refrigerants and described in Appendix B1 to ASHRAE Standard 34-2016 (as each standard exists as of the filing date of this application), which are incorporated herein by reference in its entirety (“Non-Flammability Test”). Flammability is defined as the ability of a composition to ignite and/or propagate a flame. Under this test, flammability is determined by measuring flame angles. A non-flammable substance would be classified as class “1” by ASHRAE Standard 34-2016 Designation and Safety Classification of Refrigerants (as each standard exists as of the filing date of this application).

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase “saturation temperature” means the temperature at which the liquid refrigerant boils into vapor at a given pressure.

The phrase “acceptable toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and low-toxicity would be classified as “A1” by ASHRAE Standard 34-2016 Designation and Safety Classification of Refrigerants and described in Appendix B1 to ASHRAE Standard 34-2016 (as each standard exists as of the filing date of this application).

As used herein, the term “replacement” means the use of a composition of the present invention in a heat transfer system that had been designed for use with, or is suitable for use with another refrigerant. By way of example, when a refrigerant or heat transfer composition of the present invention is used in a heat transfer system that was designed for use with R-22, then the refrigerant or heat transfer composition of the present invention is a replacement for R-22 in said system. It will thus be understood that the term “replacement” includes the use of the refrigerants and heat transfer compositions of the present invention in both new and existing systems that had been designed for use with, or are suitable for use with, a designated refrigerant, such as R-22.

The term “commercial refrigeration” refers to the cold storage equipment used in commercial settings, and includes; commercial chillers used to keep items, such as food and beverages, below the average room temperature yet above freezing; commercial freezers used to keep perishable items frozen; and commercial chiller/freezer. Examples of commercial refrigeration include: the reach-in refrigerators and freezers found in supermarkets, specialty food stores, convenience stores, drug stores, and grocery stores; walk-in freezers and refrigerators found in restaurants and cafeterias; plug-in enclosed vending machines; drop-in coolers; draft beer systems; undercounter refrigerators; refrigerated display cases and cold storage warehouses.

The term “low temperature refrigeration system” refers to heat transfer systems which operate with a condensing temperature of from about 20° C. to about 60° C. and evaporating temperature of from about −45° C. up to and including −12° C.

The term “medium temperature refrigeration system” refers to heat transfer systems which operate with a condensing temperature of from about 20° C. to about 60° C. and evaporating temperature of from −12° C. to about 0° C.

The term “degree of superheat” or simply “superheat” means the temperature rise of the refrigerant at the exit of the evaporator above the saturated vapor temperature (or dew temperature) of the refrigerant.

The terms “HFO-1234ze(E)” and transHFO-1234ze means the trans isomer of 1,3,3,3-tetrafluoropropene.

The term “HFO-1234yf” means 2,3,3,3-tetrafluoropropene.

The terms “HFO-1336mzz(E)” and each transHFO-1336mzz each meant the trans isomer of 1,1,1,4,4,4-hexafluorobut-2-ene

The terms “HFC-134a” and “R-134a” each mean 1,1,1,2-tetrafluoroethane.

The term “R-22” means chlorodifluoromethane.

The term “R-404A” means a blend of refrigerants consisting of 44 wt. %+/−2 wt. % of R-125, 52 wt. %+/−2 wt. % of R-143a, and 4 wt. %+/−2 wt. % of R134a).

The term “R407F” means a blend of refrigerants consisting of 30 wt. %+/−2 wt. % of R-32, 30 wt. %+/−2 wt. % of R-125, and 40 wt. %+/−2 wt. % of R134a).

The term “R-410A” means a blend of refrigerants consisting of 50 wt. %+0.5/−1 wt. % of R-32 and 50 wt. %+1.5/−0.5 wt. % of R125).

The term “R-448A” means a blend of refrigerants consisting of 26 wt. % of R-32, 26 wt. % of R-125, 26 wt. % of R-125, 21 wt. % of R134a; 7 wt. % of transHFO-1234ze; and 20 wt. % of HFO-1234yf).

The term “R-449A” means a blend of refrigerants consisting of 24.3 wt. % of R-32, 24.7 wt. % of R-125, 25.7 wt. % of R-134a, and 25.3 wt. % of HFO-1234yf). As used herein, the term “about” in relation to the amount expressed in weight percent for amounts greater than 2% means that the amount of the component can vary by an amount of +/−2% by weight.

For the purposes of this invention, the term “about” in relation to temperatures in degrees centigrade (° C.) means that the stated temperature can vary by an amount of +/−5° C.

### DETAILED DESCRIPTION

Refrigerants and Heat Transfer Compositions:

Applicants have found that the refrigerants of the present invention, including each of Refrigerants 1-14 as described herein, are capable of providing exceptionally advantageous properties including: heat transfer properties, acceptable toxicity and nonflammability (i.e., is Class 1A), zero or near zero ozone depletion potential (“ODP”), and lubricant compatibility, including miscibility with POE and/or PVE lubricants over the operating temperature and concentration ranges used in medium temperature refrigeration systems, low temperature refrigeration systems, cascade refrigeration systems, transport refrigeration systems, and heat pumps.

A particular advantage of the refrigerants of the present invention, including specifically each of Refrigerants 1-14, is that they are nonflammable and have acceptable toxicity, that is, each is a Class A1 refrigerant. It will be appreciated by the skilled person that the flammability of a refrigerant can be a characteristic that is given consideration in certain important heat transfer applications, and that refrigerants that are classified as Class A1 can frequently be an advantage over refrigerants that are not Class A1. Thus, it is a desire in the art to provide a refrigerant composition which can be used as a replacement for prior non-flammable refrigerants, such as R-22, R404A, R407F, R448A, R449A, R-134a. R404A and R410A 410A (or as a replacement or retrofit for R-32 and for R454B) which has excellent heat transfer properties, acceptable toxicity, zero or near zero ODP, and lubricant compatibility, including miscibility with POE and/or PVE lubricants over the operating temperature and concentration ranges used in medium and low temperature refrigeration systems, cascade refrigeration systems, transport refrigeration systems, and heat pumps (including residential air-to-water heat pump systems), and which maintains non-flammability in use. This desirable advantage can be achieved met by the refrigerants of the present invention.

Applicants have found that the refrigerant compositions of the invention, including each of Refrigerants 1-14, are capable of achieving a difficult-to-achieve combination of properties including particularly low GWP. Thus, the compositions of the invention have a GWP of 150 or less.

In addition, the refrigerant compositions of the invention, including each of Refrigerants 1-14, have a zero or near zero ODP. Thus, the compositions of the invention have an ODP of not greater than 0.02, and more preferably zero.

In addition, the refrigerant compositions of the invention, including each of Refrigerants 1-14, show acceptable toxicity and preferably have an OEL of greater than about 400. As those skilled in the art are aware, a non-flammable refrigerant that has an OEL of greater than about 400 is advantageous since it results in the refrigerant being classified in the desirable Class A of ASHRAE standard 34.

The preferred refrigerant compositions of the invention show both acceptable toxicity and nonflammability under ASHRAE standard 34, and are therefore Class A1 refrigerants. Applicants have found that the heat transfer compositions of the present invention, including heat transfer compositions that include each of Refrigerants 1-14 as described herein, are capable of providing an exceptionally advantageous and unexpected combination of properties including: good heat transfer properties, chemical stability under the conditions of use, acceptable toxicity, nonflammability, zero or near zero ozone depletion potential (“ODP”), and lubricant compatibility, including miscibility with POE and/or PVE lubricants over the operating temperature and concentration ranges used in medium and low temperature refrigeration systems, cascade refrigeration systems, transport refrigeration systems, and heat pumps (including residential air-to-water heat pump systems.

The heat transfer compositions can consist essentially of any refrigerant of the present invention, including each of Refrigerants 1-14.

The refrigerants of the invention may be provided in a heat transfer composition. Thus, the heat transfer compositions of the present invention comprise a refrigerant of the present invention, including any of the preferred refrigerant compositions disclosed herein and in particular each of Refrigerants 1-14. Preferably, the invention relates to a heat transfer composition which comprises the refrigerant, including each of Refrigerants 1-14, in an amount of at least about 80% by weight of the heat transfer composition, or at least about 90% by weight of the heat transfer composition, or at least about 97% by weight of the heat transfer composition, or at least about 99% by weight of the heat transfer composition. The heat transfer composition may consist essentially of or consist of the refrigerant.

The heat transfer compositions of the present invention can consist of any refrigerant of the present invention, including each of Refrigerants 1-14.

The heat transfer compositions of the invention may include other components for the purpose of enhancing or providing certain functionality to the compositions. Such other components may include, in addition to the refrigerant of the present invention, including each of Refrigerants 1-14, one or more of lubricants, passivators, flammability suppressants, dyes, solubilizing agents, compatibilizers, stabilizers, antioxidants, corrosion inhibitors, extreme pressure additives and anti-wear additives and other compounds and/or components that modulate a particular property of the heat transfer composition, and the presence of all such compounds and components is within the broad scope of the invention.

### Lubricants

The heat transfer compositions of the invention can comprise a refrigerant as described herein, including each of Refrigerants 1-14, and a lubricant. Heat transfer compositions as described in this paragraph are sometimes referred to for convenience as Heat Transfer Composition 1.

The heat transfer compositions of the invention can also comprise a refrigerant as described herein, including each of Refrigerants 1-14, and a polyol ester (POE) lubricant. Heat transfer compositions as described in this paragraph are sometimes referred to for convenience as Heat Transfer Composition 2.

The heat transfer composition of the invention particularly comprises Refrigerant 7 and a POE lubricant. Heat transfer compositions as described in this paragraph are sometimes referred to for convenience as Heat Transfer Composition 3.

The heat transfer composition of the invention particularly comprises Refrigerant 12 and a POE lubricant. Heat transfer compositions as described in this paragraph are sometimes referred to for convenience as Heat Transfer Composition 4.

The heat transfer composition of the invention particularly comprises Refrigerant 14 and a POE lubricant. Heat transfer compositions as described in this paragraph are sometimes referred to for convenience as Heat Transfer Composition 5.

The heat transfer composition of the invention particularly comprises Refrigerant 10 and a POE lubricant. Heat transfer compositions as described in this paragraph are sometimes referred to for convenience as Heat Transfer Composition 6.

The heat transfer composition of the invention particularly comprises Refrigerant 7 and a polyvinyl ether (PVE) lubricant. Heat transfer compositions as described in this paragraph are sometimes referred to for convenience as Heat Transfer Composition 7.

The heat transfer composition of the invention particularly comprises Refrigerant 12 and a PVE lubricant. Heat transfer compositions as described in this paragraph are sometimes referred to for convenience as Heat Transfer Composition 8.

The heat transfer composition of the invention particularly comprises Refrigerant 14 and a PVE lubricant. Heat transfer compositions as described in this paragraph are sometimes referred to for convenience as Heat Transfer Composition 9.

The heat transfer composition of the invention particularly comprises Refrigerant 10 and a PVE lubricant. Heat transfer compositions as described in this paragraph are sometimes referred to for convenience as Heat Transfer Composition 10.

Applicants have found that the heat transfer compositions of the present invention, including each of Heat Transfer Compositions 1-10 are capable of providing exceptionally advantageous properties including, in addition to the advantageous properties identified herein with respect to the refrigerant, excellent refrigerant/lubricant compatibility, including miscibility with POE and/or PVE lubricants, over the operating temperature and concentration ranges used in commercial refrigeration generally and in medium temperature refrigeration specifically. In addition, the heat transfer compositions of the present invention, including each of Heat Transfer Compositions 1-10, are capable of providing exceptionally advantageous properties including in excellent refrigerant/lubricant compatibility, including miscibility with POE and/or PVE lubricants, over the operating temperature and concentration ranges used in low temperature refrigeration, stationary air conditioning systems (including residential air conditioning, commercial air conditioning, VRF air conditioning), chillers (including air cooled chillers), and heat pump systems (including residential air-to-water heat pump systems).

A lubricant consisting essentially of a POE having a viscosity at 40° C. measured in accordance with ASTM D445 of from about 30 to about 70 is referred to herein as Lubricant 1.

Commercially available POEs that are preferred for use in the present heat transfer compositions include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred POE lubricants having the properties identified below:

| Property | RL32-3MAF | RL68H |
|---|---|---|
| Viscosity | about 31 | about 67 |
| @ 40° C. (ASTM D445), cSt | | |
| Viscosity | about 5.6 | about 9.4 |
| @ 100° C. | | |
| (ASTM D445), cSt | | |
| Pour Point | about −40 | about −40 |
| (ASTM D97), ° C. | | |

A preferred heat transfer composition comprises a refrigerant of the present invention, including each of Refrigerants 1-14 and Lubricant 1. Heat transfer compositions as described in this paragraph are sometimes referred to for convenience as Heat Transfer Composition 11.

A preferred heat transfer composition comprises Refrigerant 7 and Lubricant 1. Heat transfer compositions as described in this paragraph are sometimes referred to for convenience as Heat Transfer Composition 12.

A preferred heat transfer composition comprises Refrigerant 12 and Lubricant 1. Heat transfer compositions as described in this paragraph are sometimes referred to for convenience as Heat Transfer Composition 13.

A preferred heat transfer composition comprises Refrigerant 14 and Lubricant 1. Heat transfer compositions as described in this paragraph are sometimes referred to for convenience as Heat Transfer Composition 14.

A preferred heat transfer composition comprises Refrigerant 10 and Lubricant 1. Heat transfer compositions as described in this paragraph are sometimes referred to for convenience as Heat Transfer Composition 15.

A lubricant consisting essentially of a POE having a viscosity at 40° C. measured in accordance with ASTM D445 of from about 30 to about 70 based on the weight of the heat transfer composition, is referred to herein as Lubricant 2.

Commercially available polyvinyl ethers that are preferred for use in the present heat transfer compositions that have a viscosity at 40° C. measured in accordance with ASTM D445 of from about 30 to about 70 include those lubricants sold under the trade designations FVC32D and FVC68D, from Idemitsu.

A preferred heat transfer composition comprises a refrigerant of the present invention, including each of Refrigerants 1-14 and Lubricant 2. Heat transfer compositions as described in this paragraph are sometimes referred to for convenience as Heat Transfer Composition 16.

A preferred heat transfer composition comprises Refrigerant 7 and Lubricant 2. Heat transfer compositions as described in this paragraph are sometimes referred to for convenience as Heat Transfer Composition 17.

A preferred heat transfer composition comprises Refrigerant 12 and Lubricant 2. Heat transfer compositions as described in this paragraph are sometimes referred to for convenience as Heat Transfer Composition 18.

A preferred heat transfer composition comprises Refrigerant 14 and Lubricant 2. Heat transfer compositions as described in this paragraph are sometimes referred to for convenience as Heat Transfer Composition 19.

A preferred heat transfer composition comprises Refrigerant 10 and Lubricant 2. Heat transfer compositions as described in this paragraph are sometimes referred to for convenience as Heat Transfer Composition 20.

The invention comprises includes heat transfer compositions of the present invention, including each of Heat Transfer Compositions 1-20, wherein the lubricant is present in the heat transfer composition in an amount of from about 0.1% by weight to about 5% by weight of the heat transfer composition. Heat transfer compositions as described in this paragraph are sometimes referred to for convenience as Heat Transfer Composition 21.

The invention comprises includes heat transfer compositions of the present invention, including each of Heat Transfer Compositions 1-20, wherein the lubricant is present in the heat transfer composition in an amount of from about 0.1% by weight to about 2% by weight of the heat transfer composition. Heat transfer compositions as described in this paragraph are sometimes referred to for convenience as Heat Transfer Composition 22.

The invention comprises includes heat transfer compositions of the present invention, including each of Heat Transfer Compositions 1-20, wherein the lubricant is present in the heat transfer composition in an amount of from about 0.1% by weight to about 1% by weight of the heat transfer composition. Heat transfer compositions as described in this paragraph are sometimes referred to for convenience as Heat Transfer Composition 23.

The invention comprises includes heat transfer compositions of the present invention, including each of Heat Transfer Compositions 1-20, wherein the lubricant is present in the heat transfer composition in an amount of from about 0.1% by weight to about 0.5% by weight of the heat transfer composition. Heat transfer compositions as described in this paragraph are sometimes referred to for convenience as Heat Transfer Composition 24.

The invention comprises includes heat transfer compositions of the present invention, including each of Heat Transfer Compositions 1-20, wherein the lubricant is present in the heat transfer composition in an amount of from about 0.2% by weight to about 0.5% by weight of the heat transfer composition. Heat transfer compositions as described in this paragraph are sometimes referred to for convenience as Heat Transfer Composition 25.

Other additives not mentioned herein can also be included by those skilled in the art in view of the teaching contained herein without departing from the novel and basic features of the present invention.

Combinations of surfactants and solubilizing agents may also be added to the present compositions to aid oil solubility as disclosed in U.S. Pat. No. 6,516,837, the disclosure of which is incorporated by reference in its entirety.

### Methods, Uses and Systems

### Systems

The present invention includes heat transfer systems of all types that include refrigerants of the present invention, including each of Refrigerants 1-14, and/or that include heat transfer compositions of the invention, including each of Heat Transfer Compositions 1-25. Heat transfer systems as described in this paragraph are sometimes referred to for convenience as Heat Transfer System 1.

The present invention also includes, and provides particular advantage in connection with, low temperature refrigeration systems that include refrigerants of the present invention, including each of Refrigerants 1-14, and/or that include heat transfer compositions of the invention, including each of Heat Transfer Compositions 1-25. Heat transfer systems as described in this paragraph are sometimes referred to for convenience as Heat Transfer System 2.

The present invention also includes low temperature refrigeration systems that include Refrigerant 1. Heat transfer systems as described in this paragraph are sometimes referred to for convenience as Heat Transfer System 2A.

The present invention also includes low temperature refrigeration systems that include Refrigerant 7. Heat transfer systems as described in this paragraph are sometimes referred to for convenience as Heat Transfer System 2B.

The present invention also includes low temperature refrigeration systems that include Refrigerant 12. Heat transfer systems as described in this paragraph are sometimes referred to for convenience as Heat Transfer System 2C.

The present invention also includes low temperature refrigeration systems that include Refrigerant 13. Heat transfer systems as described in this paragraph are sometimes referred to for convenience as Heat Transfer System 2D.

The present invention also includes low temperature refrigeration systems that include Refrigerant 14. Heat transfer systems as described in this paragraph are sometimes referred to for convenience as Heat Transfer System 2E.

The present invention also includes low temperature refrigeration systems that include Heat Transfer Composition 15. Heat transfer systems as described in this paragraph are sometimes referred to for convenience as Heat Transfer System 2F.

The present invention also includes low temperature refrigeration systems that include Heat Transfer Composition 20. Heat transfer systems as described in this paragraph are sometimes referred to for convenience as Heat Transfer System 2G.

The present invention also includes, and provides particular advantage in connection with, medium temperature refrigeration systems that include refrigerants of the present invention, including each of Refrigerants 1-14, and/or that include heat transfer compositions of the invention, including each of Heat Transfer Compositions 1-25. Heat transfer systems as described in this paragraph are sometimes referred to for convenience as Heat Transfer System 3.

The present invention also includes medium temperature refrigeration systems that include Refrigerant 1. Heat transfer systems as described in this paragraph are sometimes referred to for convenience as Heat Transfer System 3A.

The present invention also includes medium temperature refrigeration systems that include Refrigerant 7. Heat transfer systems as described in this paragraph are sometimes referred to for convenience as Heat Transfer System 3B.

The present invention also includes medium temperature refrigeration systems that include Refrigerant 12. Heat transfer systems as described in this paragraph are sometimes referred to for convenience as Heat Transfer System 3C.

The present invention also includes medium temperature refrigeration systems that include Refrigerant 13. Heat transfer systems as described in this paragraph are sometimes referred to for convenience as Heat Transfer System 3D.

The present invention also includes medium temperature refrigeration systems that include Refrigerant 14. Heat transfer systems as described in this paragraph are sometimes referred to for convenience as Heat Transfer System 3E.

The present invention also includes medium temperature refrigeration systems that include Heat Transfer Composition 15. Heat transfer systems as described in this paragraph are sometimes referred to for convenience as Heat Transfer System 3F.

The present invention also includes, and provides particular advantage in connection with cascade refrigeration systems that include refrigerants of the present invention, including each of Refrigerants 1-14, and/or that include heat transfer compositions of the invention, including each of Heat Transfer Compositions 1-25. Heat transfer systems as described in this paragraph are sometimes referred to for convenience as Heat Transfer System 4.

The present invention also includes cascade refrigeration systems that include Refrigerant 1. Heat transfer systems as described in this paragraph are sometimes referred to for convenience as Heat Transfer System 4A.

The present invention also includes cascade refrigeration systems that include Refrigerant 7. Heat transfer systems as described in this paragraph are sometimes referred to for convenience as Heat Transfer System 4B.

The present invention also includes cascade refrigeration systems that include Refrigerant 12. Heat transfer systems as described in this paragraph are sometimes referred to for convenience as Heat Transfer System 4C.

The present invention also includes cascade refrigeration systems that include Refrigerant 13. Heat transfer systems as described in this paragraph are sometimes referred to for convenience as Heat Transfer System 4D.

The present invention also includes cascade refrigeration systems that include Refrigerant 14. Heat transfer systems as described in this paragraph are sometimes referred to for convenience as Heat Transfer System 4E.

The present invention also includes cascade refrigeration systems that include Heat Transfer Composition 15. Heat transfer systems as described in this paragraph are sometimes referred to for convenience as Heat Transfer System 4F.

The present invention also includes cascade refrigeration systems that include Heat Transfer Composition 20. Heat transfer systems as described in this paragraph are sometimes referred to for convenience as Heat Transfer System 4G.

The present invention also includes, and provides particular advantage in connection with, chillers (including air-cooled chillers) that include refrigerants of the present invention, including each of Refrigerants 1-14, and/or that include heat transfer compositions of the invention, including each of Heat Transfer Compositions 1-25. Heat transfer systems as described in this paragraph are sometimes referred to for convenience as Heat Transfer System 5.

The present invention also includes transport refrigeration systems that include Refrigerant 1. Heat transfer systems as described in this paragraph are sometimes referred to for convenience as Heat Transfer System 5A.

The present invention also includes transport refrigeration systems that include Refrigerant 7. Heat transfer systems as described in this paragraph are sometimes referred to for convenience as Heat Transfer System 5B.

The present invention also includes transport refrigeration systems that include Refrigerant 12. Heat transfer systems as described in this paragraph are sometimes referred to for convenience as Heat Transfer System 5C.

The present invention also includes transport refrigeration systems that include Refrigerant 13. Heat transfer systems as described in this paragraph are sometimes referred to for convenience as Heat Transfer System 5D.

The present invention also includes transport refrigeration systems that include Refrigerant 14. Heat transfer systems as described in this paragraph are sometimes referred to for convenience as Heat Transfer System 5E.

The present invention also includes transport refrigeration systems that include Heat Transfer Composition 15. Heat transfer systems as described in this paragraph are sometimes referred to for convenience as Heat Transfer System 5F.

The present invention also includes transport refrigeration systems that include Heat Transfer Composition 20. Heat transfer systems as described in this paragraph are sometimes referred to for convenience as Heat Transfer System 5G.

The present invention also includes, and provides particular advantage in connection with, heat pump systems that include refrigerants of the present invention, including each of Refrigerants 1-14, and/or that include heat transfer compositions of the invention, including each of Heat Transfer Compositions 1-25. Heat transfer systems as described in this paragraph are sometimes referred to for convenience as Heat Transfer System 6.

The present invention also includes heat pump systems (including air source heat pump water heaters) that include Refrigerant 1. Heat transfer systems as described in this paragraph are sometimes referred to for convenience as Heat Transfer System 6A.

The present invention also includes heat pump systems (including air source heat pump water heaters) that include Refrigerant 7. Heat transfer systems as described in this paragraph are sometimes referred to for convenience as Heat Transfer System 6B.

The present invention also includes heat pump systems (including air source heat pump water heaters) that include Refrigerant 12. Heat transfer systems as described in this paragraph are sometimes referred to for convenience as Heat Transfer System 6C.

The present invention also includes heat pump systems (including air source heat pump water heaters) that include Refrigerant 13. Heat transfer systems as described in this paragraph are sometimes referred to for convenience as Heat Transfer System 6D.

The present invention also includes heat pump systems (including air source heat pump water heaters) that include Refrigerant 14. Heat transfer systems as described in this paragraph are sometimes referred to for convenience as Heat Transfer System 6E.

The present invention also includes heat pump systems (including air source heat pump water heaters) that include Heat Transfer Composition 15. Heat transfer systems as described in this paragraph are sometimes referred to for convenience as Heat Transfer System 6F.

The present invention also includes heat pump systems (including air source heat pump water heaters) that include Heat Transfer Composition 20. Heat transfer systems as described in this paragraph are sometimes referred to for convenience as Heat Transfer System 6G.

The present invention also includes, and provides particular advantage in connection with, commercial refrigeration (including low temperature commercial refrigeration and medium temperature commercial refrigeration) that include refrigerants of the present invention, including each of Refrigerants 1-14, and/or that include heat transfer compositions of the invention, including each of Heat Transfer Compositions 1-25. Heat transfer systems as described in this paragraph are sometimes referred to for convenience as Heat Transfer System 7.

The present invention also includes low temperature commercial refrigeration systems that include Refrigerant 1. Heat transfer systems as described in this paragraph are sometimes referred to for convenience as Heat Transfer System 7A.

The present invention also includes low temperature commercial refrigeration systems that include Refrigerant 7. Heat transfer systems as described in this paragraph are sometimes referred to for convenience as Heat Transfer System 7B.

The present invention also includes low temperature commercial refrigeration systems that include Refrigerant 12. Heat transfer systems as described in this paragraph are sometimes referred to for convenience as Heat Transfer System 7C.

The present invention also includes low temperature commercial refrigeration systems that include Refrigerant 13. Heat transfer systems as described in this paragraph are sometimes referred to for convenience as Heat Transfer System 7D.

The present invention also includes low temperature commercial refrigeration systems that include Refrigerant 14. Heat transfer systems as described in this paragraph are sometimes referred to for convenience as Heat Transfer System 7E.

The present invention also includes low temperature commercial refrigeration systems that include Heat Transfer Composition 15. Heat transfer systems as described in this paragraph are sometimes referred to for convenience as Heat Transfer System 7F.

The present invention also includes low temperature commercial refrigeration systems that include Heat Transfer Composition 20. Heat transfer systems as described in this paragraph are sometimes referred to for convenience as Heat Transfer System 7G.

The present invention also includes medium temperature commercial refrigeration systems that include Refrigerant 1. Heat transfer systems as described in this paragraph are sometimes referred to for convenience as Heat Transfer System 7H.

The present invention also includes medium temperature commercial refrigeration systems that include Refrigerant 7. Heat transfer systems as described in this paragraph are sometimes referred to for convenience as Heat Transfer System 71.

The present invention also includes low temperature commercial refrigeration systems that include Refrigerant 12. Heat transfer systems as described in this paragraph are sometimes referred to for convenience as Heat Transfer System 7J.

The present invention also includes medium temperature commercial refrigeration systems that include Refrigerant 13. Heat transfer systems as described in this paragraph are sometimes referred to for convenience as Heat Transfer System 7K.

The present invention also includes medium temperature commercial refrigeration systems that include Refrigerant 14. Heat transfer systems as described in this paragraph are sometimes referred to for convenience as Heat Transfer System 7L.

The present invention also includes medium temperature commercial refrigeration systems that include Heat Transfer Composition 15. Heat transfer systems as described in this paragraph are sometimes referred to for convenience as Heat Transfer System 7M.

The present invention also includes medium temperature commercial refrigeration systems that include Heat Transfer Composition 20. Heat transfer systems as described in this paragraph are sometimes referred to for convenience as Heat Transfer System 7N.

For heat transfer systems of the present invention that include a compressor and lubricant for the compressor in the system, the system can comprises a loading of refrigerant of the present invention, including each of Refrigerants 1-14, and lubricant, including POE and PVE lubricant, such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

In particular aspects, heat transfer compositions of the invention comprise any one of Refrigerants 1 to 14 and lubricant in a low temperature refrigeration system as follows:

| REFRIGERANT | LUBRICANT | REFRIGERATION SYSTEM |
|---|---|---|
| Refrigerant 1 | POE or PVE | low temperature refrigeration |
| Refrigerant 2 | POE or PVE | low temperature refrigeration |
| Refrigerant 3 | POE or PVE | low temperature refrigeration |
| Refrigerant 4 | POE or PVE | low temperature refrigeration |
| Refrigerant 5 | POE or PVE | low temperature refrigeration |
| Refrigerant 6 | POE or PVE | low temperature refrigeration |
| Refrigerant 7 | POE or PVE | low temperature refrigeration |
| Refrigerant 8 | POE or PVE | low temperature refrigeration |
| Refrigerant 9 | POE or PVE | low temperature refrigeration |
| Refrigerant 10 | POE or PVE | low temperature refrigeration |
| Refrigerant 11 | POE or PVE | low temperature refrigeration |
| Refrigerant 12 | POE or PVE | low temperature refrigeration |
| Refrigerant 13 | POE or PVE | low temperature refrigeration |
| Refrigerant 14 | POE or PVE | low temperature refrigeration |

Heat transfer compositions comprise any one of Refrigerants 1 to 14 and lubricant in a medium temperature refrigeration system as follows

| REFRIGERANT | LUBRICANT | REFRIGERATION SYSTEM |
|---|---|---|
| Refrigerant 1 | POE or PVE | medium temperature refrigeration |
| Refrigerant 2 | POE or PVE | medium temperature refrigeration |
| Refrigerant 3 | POE or PVE | medium temperature refrigeration |
| Refrigerant 4 | POE or PVE | medium temperature refrigeration |
| Refrigerant 5 | POE or PVE | medium temperature refrigeration |
| Refrigerant 6 | POE or PVE | medium temperature refrigeration |
| Refrigerant 7 | POE or PVE | medium temperature refrigeration |
| Refrigerant 8 | POE or PVE | medium temperature refrigeration |
| Refrigerant 9 | POE or PVE | medium temperature refrigeration |
| Refrigerant 10 | POE or PVE | medium temperature refrigeration |
| Refrigerant 11 | POE or PVE | medium temperature refrigeration |
| Refrigerant 12 | POE or PVE | medium temperature refrigeration |
| Refrigerant 13 | POE or PVE | medium temperature refrigeration |
| Refrigerant 14 | POE or PVE | medium temperature refrigeration |

Heat transfer compositions comprise any one of Refrigerants 1 to 14 and lubricant in a retail food refrigeration system as follows:

| REFRIGERANT | LUBRICANT | REFRIGERATION SYSTEM |
|---|---|---|
| Refrigerant 1 | POE or PVE | Retail food refrigeration |
| Refrigerant 2 | POE or PVE | Retail food refrigeration |
| Refrigerant 3 | POE or PVE | Retail food refrigeration |
| Refrigerant 4 | POE or PVE | Retail food refrigeration |
| Refrigerant 5 | POE or PVE | Retail food refrigeration |
| Refrigerant 6 | POE or PVE | Retail food refrigeration |
| Refrigerant 7 | POE or PVE | Retail food refrigeration |
| Refrigerant 8 | POE or PVE | Retail food refrigeration |
| Refrigerant 9 | POE or PVE | Retail food refrigeration |
| Refrigerant 10 | POE or PVE | Retail food refrigeration |
| Refrigerant 11 | POE or PVE | Retail food refrigeration |
| Refrigerant 12 | POE or PVE | Retail food refrigeration |
| Refrigerant 13 | POE or PVE | Retail food refrigeration |
| Refrigerant 14 | POE or PVE | Retail food refrigeration |

Heat transfer compositions comprise any one of Refrigerants 1 to 14 and lubricant in a transport refrigeration system as follows:

| REFRIGERANT | LUBRICANT | REFRIGERATION SYSTEM |
|---|---|---|
| Refrigerant 1 | POE or PVE | Transport refrigeration |
| Refrigerant 2 | POE or PVE | Transport refrigeration |
| Refrigerant 3 | POE or PVE | Transport refrigeration |
| Refrigerant 4 | POE or PVE | Transport refrigeration |
| Refrigerant 5 | POE or PVE | Transport refrigeration |
| Refrigerant 6 | POE or PVE | Transport refrigeration |
| Refrigerant 7 | POE or PVE | Transport refrigeration |
| Refrigerant 8 | POE or PVE | Transport refrigeration |
| Refrigerant 9 | POE or PVE | Transport refrigeration |
| Refrigerant 10 | POE or PVE | Transport refrigeration |
| Refrigerant 11 | POE or PVE | Transport refrigeration |
| Refrigerant 12 | POE or PVE | Transport refrigeration |
| Refrigerant 13 | POE or PVE | Transport refrigeration |
| Refrigerant 14 | POE or PVE | Transport refrigeration |

### Exemplary Heat Transfer Systems

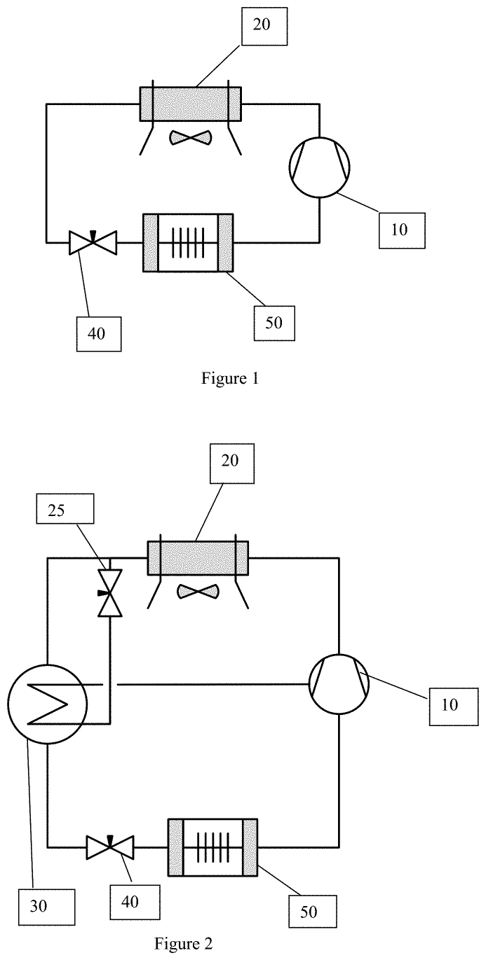

As described in detail below, the preferred systems of the present invention comprise a compressor, a condenser, an expansion device and an evaporator, all connected in fluid communication using piping, valving and control systems such that the refrigerant and associated components of the heat transfer composition can flow through the system in known fashion to complete the refrigeration cycle. An exemplary schematic of such a basic system is illustrated in FIG. 1. In particular, the system schematically illustrated in FIG. 1 shows a compressor 10, which provides compressed refrigerant vapor to condenser 20. The compressed refrigerant vapor is condensed to produce a liquid refrigerant which is then directed to an expansion device 40 that produces refrigerant at reduced temperature and pressure, which in turn is then provided to evaporator 50. In evaporator 50 the liquid refrigerant absorbs heat from the body or fluid being cooled, thus producing a refrigerant vapor which is then provided to the suction line of the compressor.

The refrigeration system illustrated in FIG. 2 is the same as described above in connection with FIG. 1 except that it includes a vapor injection system including heat exchanger 30 and bypass expansion valve 25. The bypass expansion device 25 diverts a portion of the refrigerant flow at the condenser outlet through the device and thereby provides liquid refrigerant to heat exchanger 30 at a reduced pressure, and hence at a lower temperature, to heat exchanger 30. This relatively cool liquid refrigerant then exchanges heat with the remaining, relatively high temperature liquid from the condenser. This operation produces a subcooled liquid to the main expansion device 40 and evaporator 50 and returns a relatively cool refrigerant vapor to the compressor 10. In this way the injection of the cooled refrigerant vapor into the suction side of the compressor serves to maintain compressor discharge temperatures in acceptable limits, which can be especially advantageous in low temperature systems and/or other types of systems that utilize compressors with high compression ratios.

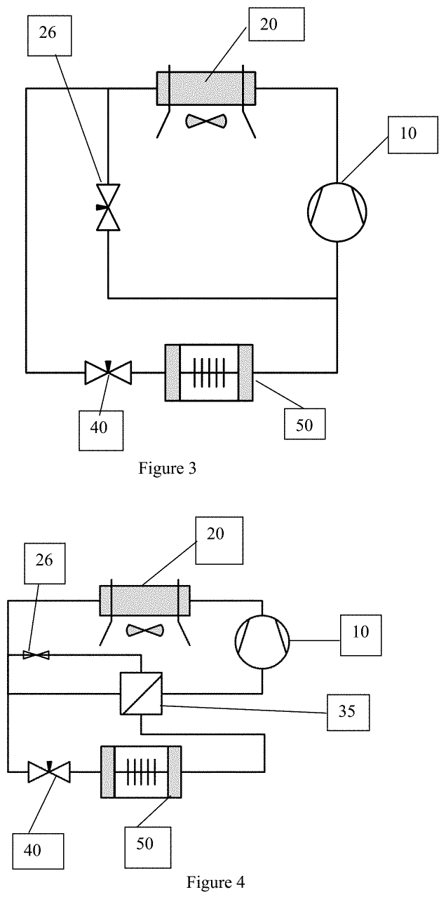

The refrigeration system illustrated in FIG. 3 is the same as described above in connection with FIG. 1 except that it includes a liquid injection system including bypass valve 26. The bypass valve 26 diverts a portion of the liquid refrigerant exiting the condenser to the compressor, preferably to a liquid injection port in the compressor 10. In this way the injection of liquid refrigerant into the suction side of the compressor serves to maintain compressor discharge temperatures in acceptable limits, which can be especially advantageous in low temperature systems that utilize compressors with high compression ratios.

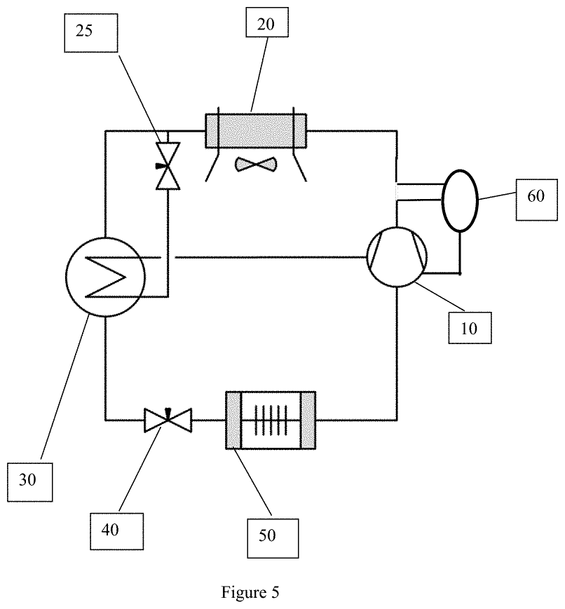

The refrigeration system illustrated in FIG. 4 is the same as described above in connection with FIG. 1 except that it includes a liquid line/suction line heat exchanger 35. The valve 25 diverts a portion of the of the refrigerant flow at the condenser outlet to the liquid line/suction line heat exchanger, where heat is transferred from the liquid refrigerant to the refrigerant vapor leaving evaporator 50.

The refrigeration system illustrated in FIG. 5 is the same as described above in connection with FIG. 1 except that it includes an oil separator 60 connected to the outlet of the compressor 10. As is known to those skilled in the art, some amount of compressor lubricant will typically be carried over into the compressor discharge refrigerant vapor, and the oil separator is included to provide means to disengage the lubricant liquid from the refrigerant vapor, and a result refrigerant vapor which has a reduced lubricant oil content, proceeds to the condenser inlet and liquid lubricant is then returned to the lubricant reservoir for use in lubricating the compressor, such as a lubricant receiver. In preferred embodiments, the oil separator includes the sequestration materials described herein, preferably in the form of a filter or solid core.

It will be appreciated by those skilled in the art that the different equipment/configuration options shown separately in each of FIGS. 2-5 can be combined and used together as deemed advantageous for any application.

Uses:

General Uses

The methods and systems of the present invention may comprise any heat transfer system and/or any heat transfer method which utilize a refrigerant, including each of Refrigerants 1-14, or a heat transfer composition comprising a refrigerant of the present invention, including each of Heat Transfer Compositions 1-25, to either absorb heat, or reject heat or both absorb and reject heat. Thus, the present invention provides uses and methods of heating or cooling a fluid or body using a refrigerant, including each of Refrigerants 1-14, or using a heat transfer composition comprising a refrigerant of the present invention, including each of Heat Transfer Compositions 1-25.

The present invention includes use of the present refrigerants in heat transfer systems as indicated by Use number in the following table, with the number in the Refrigerant column being reference to the Refrigerant number as defined herein.

| | | Refrigerant | Heat Transfer |
|---|---|---|---|
| Use Number | System Type | No. | No. |
| 1A | medium temperature refrigeration | 1-14 | NA |
| 1B | medium temperature refrigeration | 7 | NA |
| 1C | medium temperature refrigeration | 12 | NA |
| 1D | medium temperature refrigeration | 13 | NA |
| 1E | medium temperature refrigeration | 14 | NA |
| 1F | medium temperature refrigeration | NA | 1-25 |
| 1G | medium temperature refrigeration | NA | 15 |
| 1H | medium temperature refrigeration | NA | 20 |
| 2A | low temperature refrigeration | 1-14 | NA |
| 2B | low temperature refrigeration | 7 | NA |
| 2C | low temperature refrigeration | 12 | NA |
| 2D | low temperature refrigeration | 13 | NA |
| 2E | low temperature refrigeration | 14 | NA |
| 2F | low temperature refrigeration | NA | 1-25 |
| 2G | low temperature refrigeration | NA | 15 |
| 2H | low temperature refrigeration | NA | 20 |
| 3A | cascade refrigeration | 1-14 | NA |
| 3B | cascade refrigeration | 7 | NA |
| 3C | cascade refrigeration | 12 | NA |
| 3D | cascade refrigeration | 13 | NA |
| 3E | cascade refrigeration | 14 | NA |
| 3F | cascade refrigeration | NA | 1-25 |
| 3G | cascade refrigeration | NA | 15 |
| 3H | cascade refrigeration | NA | 20 |
| 4A | heat pump | 1-14 | NA |
| 4B | heat pump | 7 | NA |
| 4C | heat pump | 12 | NA |
| 4D | heat pump | 13 | NA |
| 4E | heat pump | 14 | NA |
| 4F | heat pump | NA | 1-25 |
| 4F | heat pump | NA | 15 |
| 4G | heat pump | NA | 20 |
| 5A | transport refrigeration | 1-14 | NA |
| 5B | transport refrigeration | 7 | NA |
| 5C | transport refrigeration | 12 | NA |
| 5D | transport refrigeration | 13 | NA |
| 5E | transport refrigeration | 14 | NA |
| 5F | transport refrigeration | NA | 1-25 |
| F | transport refrigeration | NA | 15 |
| 4G | transport refrigeration | NA | 20 |
| 5A | stationary VRF air conditioning systems | 1 | |
| 5B | stationary VRF air conditioning systems | 7 | |
| 5C | stationary VRF air conditioning systems | 8 | |
| 5D | stationary VRF air conditioning systems | 9 | |
| 5E | stationary VRF air conditioning systems | 10 | |
| 5F | stationary VRF air conditioning systems | NA | 15 |
| 5G | stationary VRF air conditioning systems | NA | 20 |
| 6A | chillers (including air-cooled chillers) | 1 | |
| 6B | chillers (including air-cooled chillers) | 7 | |
| 6C | chillers (including air-cooled chillers) | 8 | |
| 6D | chillers (including air-cooled chillers) | 9 | |
| 6E | chillers (including air-cooled chillers) | 10 | |
| 6F | chillers (including air-cooled chillers) | NA | 15 |
| 6G | chillers (including air-cooled chillers) | NA | 20 |

### Replacement Uses

The present invention also includes, and provides particular advantage in connection with, use of the refrigerants of the present invention, including each of Refrigerants 1-14, as a replacement for various existing refrigerants. The various replacement uses described in the following table are included in the present invention, with the number in the Replacement Refrigerant being reference to the Refrigerant Number as defined herein.

| Existing | | Replacement |
|---|---|---|
| Refrigerant | Existing Refrigerant System | Refrigerant |
| R22 | All | 1-14 |
| R22 | All | 7 |
| R22 | All | 12 |
| R22 | All | 13 |
| R22 | All | 14 |
| R404A | All | 1-14 |
| R404A | All | 7 |
| R404A | All | 12 |
| R404A | All | 13 |
| R404A | All | 14 |
| R407F | All | 1-14 |
| R407F | All | 7 |
| R407F | All | 12 |
| R407F | All | 13 |
| R407F | All | 14 |
| R448A | All | 1-14 |
| R448A | All | 7 |
| R448A | All | 12 |
| R448A | All | 13 |
| R448A | All | 14 |
| R449A | All | 1-14 |
| R449A | All | 7 |
| R449A | All | 12 |
| R449A | All | 13 |
| R449A | All | 14 |
| R134a | All | 1-14 |
| R134a | All | 7 |
| R134a | All | 12 |
| R134a | All | 13 |
| R134a | All | 14 |
| R410A | All | 1-14 |
| R410A | All | 7 |
| R410A | All | 12 |
| R410A | All | 13 |
| R410A | All | 14 |
| R22 | medium temperature refrigeration | 1-14 |
| R22 | medium temperature refrigeration | 7 |
| R22 | medium temperature refrigeration | 12 |
| R22 | medium temperature refrigeration | 13 |
| R22 | medium temperature refrigeration | 14 |
| R404A | medium temperature refrigeration | 1-14 |
| R404A | medium temperature refrigeration | 7 |
| R404A | medium temperature refrigeration | 12 |
| R404A | medium temperature refrigeration | 13 |
| R404A | medium temperature refrigeration | 14 |
| R407F | medium temperature refrigeration | 1-14 |
| R407F | medium temperature refrigeration | 7 |
| R407F | medium temperature refrigeration | 12 |
| R407F | medium temperature refrigeration | 13 |
| R407F | medium temperature refrigeration | 14 |
| R448A | medium temperature refrigeration | 1-14 |
| R448A | medium temperature refrigeration | 7 |
| R448A | medium temperature refrigeration | 12 |
| R448A | medium temperature refrigeration | 13 |
| R448A | medium temperature refrigeration | 14 |
| R449A | medium temperature refrigeration | 1-14 |
| R449A | medium temperature refrigeration | 7 |
| R449A | medium temperature refrigeration | 12 |
| R449A | medium temperature refrigeration | 13 |
| R449A | medium temperature refrigeration | 14 |
| R134a | medium temperature refrigeration | 1-14 |
| R134a | medium temperature refrigeration | 7 |
| R134a | medium temperature refrigeration | 12 |
| R134a | medium temperature refrigeration | 13 |
| R134a | medium temperature refrigeration | 14 |
| R410A | medium temperature refrigeration | 1-14 |
| R410A | medium temperature refrigeration | 7 |
| R410A | medium temperature refrigeration | 12 |
| R410A | medium temperature refrigeration | 13 |
| R410A | medium temperature refrigeration | 14 |
| R22 | low temperature refrigeration | 1-14 |
| R22 | low temperature refrigeration | 7 |
| R22 | low temperature refrigeration | 12 |
| R22 | low temperature refrigeration | 13 |
| R22 | low temperature refrigeration | 14 |
| R404A | low temperature refrigeration | 1-14 |
| R404A | low temperature refrigeration | 7 |
| R404A | low temperature refrigeration | 12 |
| R404A | low temperature refrigeration | 13 |
| R404A | low temperature refrigeration | 14 |
| R407F | low temperature refrigeration | 1-14 |
| R407F | low temperature refrigeration | 7 |
| R407F | low temperature refrigeration | 12 |
| R407F | low temperature refrigeration | 13 |
| R407F | low temperature refrigeration | 14 |
| R448A | low temperature refrigeration | 1-14 |
| R448A | low temperature refrigeration | 7 |
| R448A | low temperature refrigeration | 12 |
| R448A | low temperature refrigeration | 13 |
| R448A | low temperature refrigeration | 14 |
| R449A | low temperature refrigeration | 1-14 |
| R449A | low temperature refrigeration | 7 |
| R449A | low temperature refrigeration | 12 |
| R449A | low temperature refrigeration | 13 |
| R449A | low temperature refrigeration | 14 |
| R134a | low temperature refrigeration | 1-14 |
| R134a | low temperature refrigeration | 7 |
| R134a | low temperature refrigeration | 12 |
| R134a | low temperature refrigeration | 13 |
| R134a | low temperature refrigeration | 14 |
| R410A | low temperature refrigeration | 1-14 |
| R410A | low temperature refrigeration | 7 |
| R410A | low temperature refrigeration | 12 |
| R410A | low temperature refrigeration | 13 |
| R410A | low temperature refrigeration | 14 |
| R22 | heat pumps | 1-14 |
| R22 | heat pumps | 7 |
| R22 | heat pumps | 12 |
| R22 | heat pumps | 13 |
| R22 | heat pumps | 14 |
| R404A | heat pumps | 1-14 |
| R404A | heat pumps | 7 |
| R404A | heat pumps | 12 |
| R404A | heat pumps | 13 |
| R404A | heat pumps | 14 |
| R407F | heat pumps | 1-14 |
| R407F | heat pumps | 7 |
| R407F | heat pumps | 12 |
| R407F | heat pumps | 13 |
| R407F | heat pumps | 14 |
| R448A | heat pumps | 1-14 |
| R448A | heat pumps | 7 |
| R448A | heat pumps | 12 |
| R448A | heat pumps | 13 |
| R448A | heat pumps | 14 |
| R449A | heat pumps | 1-14 |
| R449A | heat pumps | 7 |
| R449A | heat pumps | 12 |
| R449A | heat pumps | 13 |
| R449A | heat pumps | 14 |
| R134a | heat pumps | 1-14 |
| R134a | heat pumps | 7 |
| R134a | heat pumps | 12 |
| R134a | heat pumps | 13 |
| R134a | heat pumps | 14 |
| R410A | heat pumps | 1-14 |
| R410A | heat pumps | 7 |
| R410A | heat pumps | 12 |
| R410A | heat pumps | 13 |
| R410A | heat pumps | 14 |
| R22 | transport refrigeration | 1-14 |
| R22 | transport refrigeration | 7 |
| R22 | transport refrigeration | 12 |
| R22 | transport refrigeration | 13 |
| R22 | transport refrigeration | 14 |
| R404A | transport refrigeration | 1-14 |
| R404A | transport refrigeration | 7 |
| R404A | transport refrigeration | 12 |
| R404A | transport refrigeration | 13 |
| R404A | transport refrigeration | 14 |
| R407F | transport refrigeration | 1-14 |
| R407F | transport refrigeration | 7 |
| R407F | transport refrigeration | 12 |
| R407F | transport refrigeration | 13 |
| R407F | transport refrigeration | 14 |
| R448A | transport refrigeration | 1-14 |
| R448A | transport refrigeration | 7 |
| R448A | transport refrigeration | 12 |
| R448A | transport refrigeration | 13 |
| R448A | transport refrigeration | 14 |
| R449A | transport refrigeration | 1-14 |
| R449A | transport refrigeration | 7 |
| R449A | transport refrigeration | 12 |
| R449A | transport refrigeration | 13 |
| R449A | transport refrigeration | 14 |
| R134a | transport refrigeration | 1-14 |
| R134a | transport refrigeration | 7 |
| R134a | transport refrigeration | 12 |
| R134a | transport refrigeration | 13 |
| R134a | transport refrigeration | 14 |
| R410A | transport refrigeration | 1-14 |
| R410A | transport refrigeration | 7 |
| R410A | transport refrigeration | 12 |
| R410A | transport refrigeration | 13 |
| R410A | transport refrigeration | 14 |
| R22 | cascade refrigeration | 1-14 |
| R22 | cascade refrigeration | 7 |
| R22 | cascade refrigeration | 12 |
| R22 | cascade refrigeration | 13 |
| R22 | cascade refrigeration | 14 |
| R404A | cascade refrigeration | 1-14 |
| R404A | cascade refrigeration | 7 |
| R404A | cascade refrigeration | 12 |
| R404A | cascade refrigeration | 13 |
| R404A | cascade refrigeration | 14 |
| R407F | cascade refrigeration | 1-14 |
| R407F | cascade refrigeration | 7 |
| R407F | cascade refrigeration | 12 |
| R407F | cascade refrigeration | 13 |
| R407F | cascade refrigeration | 14 |
| R448A | cascade refrigeration | 1-14 |
| R448A | cascade refrigeration | 7 |
| R448A | cascade refrigeration | 12 |
| R448A | cascade refrigeration | 13 |
| R448A | cascade refrigeration | 14 |
| R449A | cascade refrigeration | 1-14 |
| R449A | cascade refrigeration | 7 |
| R449A | cascade refrigeration | 12 |
| R449A | cascade refrigeration | 13 |
| R449A | cascade refrigeration | 14 |
| R134a | cascade refrigeration | 1-14 |
| R134a | cascade refrigeration | 7 |
| R134a | cascade refrigeration | 12 |
| R134a | cascade refrigeration | 13 |
| R134a | cascade refrigeration | 14 |
| R410A | cascade refrigeration | 1-14 |
| R410A | cascade refrigeration | 7 |
| R410A | cascade refrigeration | 12 |
| R410A | cascade refrigeration | 13 |
| R410A | cascade refrigeration | 14 |
| R410A | stationary air conditioning | 8 |
| R410A | stationary air conditioning | 9 |
| R410A | stationary air conditioning | 10 |
| R410A | stationary residential air conditioning | 1 |
| R410A | stationary residential air conditioning | 2 |
| R410A | stationary residential air conditioning | 3 |
| R410A | stationary residential air conditioning | 4 |
| R410A | stationary residential air conditioning | 5 |
| R410A | stationary residential air conditioning | 6 |
| R410A | stationary residential air conditioning | 7 |
| R410A | stationary residential air conditioning | 8 |
| R410A | stationary residential air conditioning | 9 |
| R410A | stationary residential air conditioning | 10 |
| R410A | stationary commercial air conditioning | 1 |
| R410A | stationary commercial air conditioning | 2 |
| R410A | stationary commercial air conditioning | 3 |
| R410A | stationary commercial air conditioning | 4 |
| R410A | stationary commercial air conditioning | 5 |
| R410A | stationary commercial air conditioning | 6 |
| R410A | stationary commercial air conditioning | 7 |
| R410A | stationary commercial air conditioning | 8 |
| R410A | stationary commercial air conditioning | 9 |
| R410A | stationary commercial air conditioning | 10 |
| R410A | stationary residential air conditioning | 10 |
| R410A | stationary VRF air conditioning | 1 |
| R410A | stationary VRF air conditioning | 2 |
| R410A | stationary VRF air conditioning | 3 |
| R410A | stationary VRF air conditioning | 4 |
| R410A | stationary VRF air conditioning | 5 |
| R410A | stationary VRF air conditioning | 6 |
| R410A | stationary VRF air conditioning | 7 |
| R410A | stationary VRF air conditioning | 8 |
| R410A | stationary VRF air conditioning | 9 |
| R410A | stationary VRF air conditioning | 10 |
| R410A | chiller (including air cooled chillers) | 1 |
| R410A | chiller (including air cooled chillers) | 2 |
| R410A | chiller (including air cooled chillers) | 3 |
| R410A | chiller (including air cooled chillers) | 4 |
| R410A | chiller (including air cooled chillers) | 5 |
| R410A | chiller (including air cooled chillers) | 6 |
| R410A | chiller (including air cooled chillers) | 7 |
| R410A | chiller (including air cooled chillers) | 8 |
| R410A | chiller (including air cooled chillers) | 9 |
| R410A | chiller (including air cooled chillers) | 10 |
| R410A | heat pump | 1 |
| R410A | heat pump | 2 |
| R410A | heat pump | 3 |
| R410A | heat pump | 4 |
| R410A | heat pump | 5 |
| R410A | heat pump | 6 |
| R410A | heat pump | 7 |
| R410A | heat pump | 8 |
| R410A | heat pump | 9 |
| R410A | heat pump | 10 |
| R410A | residential air-to-water heat pump | 1 |
| R410A | residential air-to-water heat pump | 2 |
| R410A | residential air-to-water heat pump | 3 |
| R410A | residential air-to-water heat pump | 4 |
| R410A | residential air-to-water heat pump | 5 |
| R410A | residential air-to-water heat pump | 6 |
| R410A | residential air-to-water heat pump | 7 |
| R410A | residential air-to-water heat pump | 8 |
| R410A | residential air-to-water heat pump | 9 |
| R410A | residential air-to-water heat pump | 10 |
| R410A | commercial refrigeration | 1 |
| R410A | commercial refrigeration | 2 |
| R410A | commercial refrigeration | 3 |
| R410A | commercial refrigeration | 4 |
| R410A | commercial refrigeration | 5 |
| R410A | commercial refrigeration | 6 |
| R410A | commercial refrigeration | 7 |
| R410A | commercial refrigeration | 8 |
| R410A | commercial refrigeration | 9 |
| R410A | commercial refrigeration | 10 |
| R410A | commercial low temperature refrigeration | 1 |
| R410A | commercial low temperature refrigeration | 2 |
| R410A | commercial low temperature refrigeration | 3 |
| R410A | commercial low temperature refrigeration | 4 |
| R410A | commercial low temperature refrigeration | 5 |
| R410A | commercial low temperature refrigeration | 6 |
| R410A | commercial low temperature refrigeration | 7 |
| R410A | commercial low temperature refrigeration | 8 |
| R410A | commercial low temperature refrigeration | 9 |
| R410A | commercial low temperature refrigeration | 10 |
| R410A | commercial medium temperature refrigeration | 1 |
| R410A | commercial medium temperature refrigeration | 2 |
| R410A | commercial medium temperature refrigeration | 3 |
| R410A | commercial medium temperature refrigeration | 4 |
| R410A | commercial medium temperature refrigeration | 5 |
| R410A | commercial medium temperature refrigeration | 6 |
| R410A | commercial medium temperature refrigeration | 7 |
| R410A | commercial medium temperature refrigeration | 8 |
| R410A | commercial medium temperature refrigeration | 9 |
| R410A | commercial medium temperature refrigeration | 10 |

Cooling Methods

The present invention includes methods for providing cooling comprising:

(a) evaporating a refrigerant according to the present invention (including any refrigerant selected from each of Refrigerants 1-14), in the vicinity of the body or article or fluid to be cooled;

(b) compressing said refrigerant vapor to produce a refrigerant at discharge temperature of less than about 150° C.; and

(c) condensing the refrigerant from said compressor. Cooling methods in accordance with this paragraph are referred to herein as Cooling Method 1.

The present invention comprises carrying out cooling in accordance with Cooling Method 1 using a heat transfer system of the present invention, including each of Heat Transfer Systems 1-7.

The present invention includes methods for providing cooling comprising:

(a) evaporating a refrigerant according to the present invention (including any refrigerant selected from each of Refrigerants 1-14), in the vicinity of the body or article or fluid to be cooled at a temperature of from about −40° C. to about +100C to produce a refrigerant vapor;

(b) compressing said refrigerant vapor to produce a refrigerant at discharge temperature of less than about 150° C.; and

(c) condensing the refrigerant from said compressor at a temperature of from about 20° C. to about 70° C. to produce a refrigerant vapor. Cooling methods in accordance with this paragraph are referred to herein as Cooling Method 2.

The present invention comprises carrying out cooling in accordance with Cooling Method 2 using a heat transfer system of the present invention, including each of Heat Transfer Systems 1-7.

The present invention includes methods according to Cooling Method 1 wherein the refrigerant in said evaporating step has a refrigerant glide of less than 3.0° C. Cooling methods in accordance with this paragraph are referred to herein as Cooling Method 3.

The present invention comprises carrying out cooling in accordance with Cooling Method 3 using a heat transfer system of the present invention, including each of Heat Transfer Systems 1-7.

The present invention includes methods according to Cooling Method 1 wherein the refrigerant in said evaporating step has a refrigerant glide of less than 2.5° C. Cooling methods in accordance with this paragraph are referred to herein as Cooling Method 4.

The present invention comprises carrying out cooling in accordance with Cooling Method 4 using a heat transfer system of the present invention, including each of Heat Transfer Systems 1-7.

The present invention includes conducting cooling according to any of Cooling Methods 1-4 in a medium temperature refrigeration system.

The present invention includes conducting cooling according to any of Cooling Methods 1-4 in a low temperature refrigeration system.

The present invention includes conducting cooling according to any of Cooling Methods 1-4 in a transport refrigeration system.

The present invention includes conducting cooling according to any of Cooling Methods 1-4 in a cascade refrigeration system.

The present invention includes conducting cooling according to any of Cooling Methods 1-4 in an electronic cooling system.

The present invention includes conducting cooling according to any of Cooling Methods 1-4 in a heat pump system.

The present invention includes conducting cooling according to any of Cooling Methods 1-4 in a commercial refrigeration system.

The present invention includes conducting cooling according to any of Cooling Methods 1-4 in a commercial low temperature refrigeration system.

The present invention includes conducting cooling according to any of Cooling Methods 1-4 in a commercial medium temperature refrigeration system.

Particular cooling methods are described in more detail below.

Applicants have found that substantial advantage can be achieved in connection with heat transfer methods in which a refrigerant, including each of Refrigerants 1-14, or heat transfer composition of the present invention that includes a refrigerant of the present invention, including Heat Transfer Compositions 1-25, is used to absorb heat from a fluid surrounding an article, or otherwise in thermal communication to with the article itself, such as might occur to cool produce and/or other refrigerated food, or as might occur in connection with the cooling of certain electronic devices. In such cases, the fluid may be air or a secondary coolant (for example: water, glycol, water/glycol mixtures, brine, etc.), such as would occur in the case of the refrigerant being used in an evaporator in systems and methods which require that the temperature of the article or fluid being cooled is not exposed to temperatures below a certain limit.

Thus, in general, the present methods utilize apparatus and/or processes which permit the refrigerant or heat transfer composition of the present invention to absorb heat and also apparatus and/or processes which then remove the absorbed heat from the refrigerant.

It will be appreciated that the evaporator which is used to absorb heat from the article or fluid being cooled may include conduits and the like, such as for example cooling coils, through which the refrigerant flows, including each of Refrigerants 1-14, while such conduit is being exposed to the article or fluid (directly or indirectly) to be cooled. In this way, heat flows from the fluid (e.g. air) being cooled and/or the article located in the vicinity (such as fresh produce, such as fruits, vegetables, and flowers) through the metal or other heat conductive material of the conduit and into the refrigerant of the present invention, including each of Refrigerants 1-14.

Applicants have discovered that the refrigerant compositions of the present invention, including each of Refrigerants 1-14, are evaporated in methods and systems which have an evaporator glide that is less than about 3° C., and even more preferably less than about 2.5° C. Applicants have found that such characteristics are beneficial for refrigeration systems in general, and of particular benefit in medium temperature refrigeration systems, low temperature refrigeration systems, cascade systems, transport refrigeration systems, and heat pumps systems. In preferred embodiments, the methods of the present invention, including each of Cooling Methods 1-4, produce cooled air in which the cooled discharge air is controlled at a temperature of from about 2° C. to about 5° C., when the cooled discharge air is at a temperature of from about 2° C. to about 4° C., and more preferably in certain embodiments (such as cooling fresh cut fruit, vegetables, and flowers for example), the cooled discharge air is at a temperature of from about 2° C. to about 3° C. Specific systems and methods of the invention are described below.

Refrigeration Methods The present invention also provides a method for cooling a fluid or body using a refrigeration system wherein the method comprises the steps of (a) evaporating a refrigerant composition of the invention, including each of Refrigerants 1-14, in the vicinity of the fluid or body to be cooled, and (b) condensing the refrigerant. The particular and preferred operation of preferred heat transfer methods are described below.

### Medium Temperature Refrigeration Methods

The refrigerant and heat transfer compositions of the invention can be used in any refrigeration system. However, Applicants have found that the present refrigerants, including each of Refrigerants 1-14, and the present heat transfer compositions comprising a refrigerant of the present invention, including each of Heat Transfer Compositions 1-25, provide a particular advantage in medium temperature refrigeration systems. Thus, the present invention provides a method of cooling a fluid or body in a medium temperature refrigeration system, the method comprising the steps of (a) evaporating a refrigerant composition of the invention, including eh of Refrigerants 1-14, or heat transfer composition comprising a refrigerant of the present invention, including each of Heat Transfer Composition 1-25, in the vicinity of the fluid or body to be cooled, and (b) condensing the refrigerant, wherein the evaporator temperature is from about −15° C. to about 5° C., more preferably from about −10° C. to about 5° C.

Thus, the present invention provides a method of cooling a fluid or body in a medium temperature refrigeration system, the method comprising the steps of (a) evaporating Refrigerants 1 in the vicinity of the fluid or body to be cooled, and (b) condensing the refrigerant, wherein the evaporator temperature is from about −15° C. to about 5° C., more preferably from about −10° C. to about 5° C.

Thus, the present invention provides a method of cooling a fluid or body in a medium temperature refrigeration system, the method comprising the steps of (a) evaporating Refrigerants 7 in the vicinity of the fluid or body to be cooled, and (b) condensing the refrigerant, wherein the evaporator temperature is from about −15° C. to about 5° C., more preferably from about −10° C. to about 5° C.

Thus, the present invention provides a method of cooling a fluid or body in a medium temperature refrigeration system, the method comprising the steps of (a) evaporating Refrigerants 12 in the vicinity of the fluid or body to be cooled, and (b) condensing the refrigerant, wherein the evaporator temperature is from about −15° C. to about 5° C., more preferably from about −10° C. to about 5° C.

Thus, the present invention provides a method of cooling a fluid or body in a medium temperature refrigeration system, the method comprising the steps of (a) evaporating Refrigerants 13 in the vicinity of the fluid or body to be cooled, and (b) condensing the refrigerant, wherein the evaporator temperature is from about −15° C. to about 5° C., more preferably from about −10° C. to about 5° C.

Thus, the present invention provides a method of cooling a fluid or body in a medium temperature refrigeration system, the method comprising the steps of (a) evaporating Refrigerants 14 in the vicinity of the fluid or body to be cooled, and (b) condensing the refrigerant, wherein the evaporator temperature is from about −15° C. to about 5° C., more preferably from about −10° C. to about 5° C.

A medium temperature refrigeration system as used herein refers to a refrigeration system that utilizes one or more compressors and operates under or within the following conditions: (a) a condenser temperature of from about 15° C. to about 60° C., preferably from about 25° C. to about 45° C.; (b) evaporator temperature of from about −15° C. to about 5° C., preferably from about −10° C. to about 5° C.; optionally (c) a degree of superheat at evaporator outlet of from about 0° C. to about 10° C., preferably with a degree of superheat at evaporator outlet of from about 1° C. to about 6° C.; and optionally (d) a degree of superheat in the suction line of from about 5° C. to about 40° C., preferably with a degree of superheat in the suction line of from about 15° C. to about 30° C. The superheat along the suction line may also be generated by a heat exchanger.

Examples of medium temperature refrigeration systems and medium temperature refrigeration methods include small refrigeration systems (including vending machines, ice machines, and appliances), commercial refrigeration systems (such as supermarket refrigeration systems and walk-in coolers), residential refrigeration systems, industrial refrigeration systems (including industrial process refrigeration), and ice rinks.

In the case of the storage of perishable produce such as vegetables and fruits in a medium temperature refrigeration system or using medium temperature refrigeration method, for example, the fluid to be cooled is air having a desired cooled temperature of from about 2° C. to about 5° C., and preferably from about 2° C. to about 4° C., and more preferably (such as cooling fresh cut fruit, vegetables, and flowers for example), from about 2° C. to about 3° C. Furthermore, in many applications, it is preferred that the refrigerant temperature along the evaporator does not reach below about 0° C. (freezing point of water) to avoid the formation of frost. Preferably, at the same time, the superheat at the exit of the evaporator should be maintained at a typical value of from about 3° C. to about 5° C., and preferably about 4° C.

Therefore, the invention includes medium temperature refrigeration methods comprising a refrigerant, including each of Refrigerants 1-14, or heat transfer composition comprising a refrigerant of the present invention, including each of Heat Transfer Compositions 1-25 wherein the evaporator temperature of refrigerant is from about 0° C. to about 5° C.

Therefore, the invention includes medium temperature refrigeration methods comprising evaporating Refrigerant 1 at temperature of from about 0° C. to about 5° C.

Therefore, the invention includes medium temperature refrigeration methods comprising evaporating Refrigerant 7 at temperature of from about 0° C. to about 5° C.

Therefore, the invention includes medium temperature refrigeration methods comprising evaporating Refrigerant 12 at temperature of from about 0° C. to about 5° C.

Therefore, the invention includes medium temperature refrigeration methods comprising evaporating Refrigerant 13 at temperature of from about 0° C. to about 5° C.

Therefore, the invention includes medium temperature refrigeration methods comprising evaporating Refrigerant 15 at temperature of from about 0° C. to about 5° C.

Cascade Refrigeration Methods

The present invention also includes cascade refrigeration methods comprising a refrigerant or heat transfer composition of the invention. Generally, a cascade system has two or more stages. When a cascade system has two stages, these are generally referred to as the upper stage and the lower stage. The refrigerant of the invention, including each of Refrigerants 1-14, or heat transfer compositions comprising a refrigerant of the present invention, including each of Heat Transfer Compositions 1-25 may be used in either the upper or lower stage of a cascade refrigeration system. However, it is preferred that the refrigerant of the invention, including each of Refrigerants 1-14, or a heat transfer composition comprising a refrigerant of the present invention, including each of Heat Transfer Compositions is used in the upper stage of a cascade system. In view of the teachings contained herein, a person skilled in the art will be able to determine suitable refrigerants for use in the lower stage of the cascade system, and include for example CO2, R1234yf, and R455A. R455A is a blend of 75.5% R1234yf, 21.5% R32, and 3% CO2. In cascade systems, the present refrigerants may replace, for example, R404A.

Low Temperature Refrigeration Methods

The present invention also provides low temperature refrigeration methods comprising a refrigerant, including each of Refrigerants 1-14, or heat transfer composition comprising a refrigerant of the present invention, including each of Heat Transfer Compositions 1-25. The present invention also provides a method of cooling a fluid or body in a low temperature refrigeration system, said method comprising the steps of (a) evaporating a refrigerant composition of the invention, including each of Refrigerants 1-14, in the vicinity of the fluid or body to be cooled, and (b) condensing said refrigerant. Preferably the temperature of the refrigerant in the evaporator is from about −40° C. to less than about −15° C., more preferably from about −40° C. to about −25° C.

The present invention also provides a method of cooling a fluid or body in a low temperature refrigeration system, said method comprising the steps of (a) evaporating a Refrigerant 1 in the vicinity of the fluid or body to be cooled, and (b) condensing said refrigerant, wherein the temperature of the refrigerant in the evaporator is from about −40° C. to less than about −15° C., more preferably from about −40° C. to about −25° C.

The present invention also provides a method of cooling a fluid or body in a low temperature refrigeration system, said method comprising the steps of (a) evaporating a Refrigerant 7 in the vicinity of the fluid or body to be cooled, and (b) condensing said refrigerant, wherein the temperature of the refrigerant in the evaporator is from about −40° C. to less than about −15° C., more preferably from about −40° C. to about −25° C.

The present invention also provides a method of cooling a fluid or body in a low temperature refrigeration system, said method comprising the steps of (a) evaporating a Refrigerant 12 in the vicinity of the fluid or body to be cooled, and (b) condensing said refrigerant, wherein the temperature of the refrigerant in the evaporator is from about −40° C. to less than about −15° C., more preferably from about −40° C. to about −25° C.

The present invention also provides a method of cooling a fluid or body in a low temperature refrigeration system, said method comprising the steps of (a) evaporating a Refrigerant 13 in the vicinity of the fluid or body to be cooled, and (b) condensing said refrigerant, wherein the temperature of the refrigerant in the evaporator is from about −40° C. to less than about −15° C., more preferably from about −40° C. to about −25° C.

The present invention also provides a method of cooling a fluid or body in a low temperature refrigeration system, said method comprising the steps of (a) evaporating a Refrigerant 14 in the vicinity of the fluid or body to be cooled, and (b) condensing said refrigerant, wherein the temperature of the refrigerant in the evaporator is from about −40° C. to less than about −15° C., more preferably from about −40° C. to about −25° C.

A low temperature refrigeration system as used herein to refers to a refrigeration system that utilizes one or more compressors and operates under or within the following conditions: (a) condenser temperature from about 15° C. to about 50° C., preferably of from about 25° C. to about 45° C.; (b) evaporator temperature from about −40° C. to about or less than about −15° C., preferably from about −40° C. to about −25° C.; optionally (c) a degree of superheat at evaporator outlet of from about 0° C. to about 10° C., preferably of from about 1° C. to about 6° C.; and optionally (d) a degree of superheat in the suction line of from about 15° C. to about 40° C., preferably of from about 20° C. to about 30° C.

Examples of low temperature refrigeration systems and methods include supermarket refrigeration systems, commercial freezer systems (including supermarket freezers), residential freezer systems, and industrial freezer systems. The low temperature refrigeration system may be used, for example, to cool frozen goods.

### Transport Refrigeration Methods

Transport refrigeration creates the link in the cold chain allowing frozen or chilled produce to reach the end user in the correct temperature environment. The present invention relates to a transport refrigeration system comprising a refrigerant of the invention, including each of Refrigerants 1-14, or heat transfer composition comprising a refrigerant of the present invention, including each of Heat Transfer Compositions. Examples of transport refrigeration include refrigerated road vehicles (such as trucks and vans), train railcars, and containers capable of being transported by road vehicles, trains, and ships/boats.

Heat Pump Methods

The present invention relates to a heat pump methods comprising a refrigerant of the invention, including each of Refrigerants 1-14, or a heat transfer composition comprising a refrigerant of the present invention, including each of Heat Transfer Compositions 1-14.

The present invention also provides a method of heating a fluid or body using a heat pump, the method comprising the steps of (a) condensing a refrigerant composition of the invention, including each of Refrigerants 1-14, in the vicinity of the fluid or body to be heated, and (b) evaporating the refrigerant. Examples of heat pumps include heat pump tumble driers, reversible heat pumps, high temperature heat pumps, and air-to-air heat pumps.

Secondary Loop Methods

The refrigerant of the present invention, including each of Refrigerants 1-14, or heat transfer composition comprising a refrigerant of the present invention, including each of Refrigerants 1-14 may be used as secondary fluid in a secondary loop system. A secondary loop system contains a primary vapor compression system loop that uses a primary refrigerant and has an evaporator that cools the secondary loop fluid. The secondary fluid then provides the necessary cooling for an application. The secondary fluid must be non-flammable and have low-toxicity since the refrigerant in such a loop is potentially exposed to humans in the vicinity of the cooled space. In other words, the refrigerant of the present invention, including each of Refrigerants 1-14, may be used as a “secondary fluid”. A primary fluid for use in the primary loop (vapor compression cycle, external/outdoors part of the loop) may include the following refrigerants but not limited to R404A, R507, R410A, R455A, R32, R466A, R44B, R290, R717, R452B, R448A, R1234ze(E), R1234yf, and R449A.

Air Conditioning Methods

The present invention relates to an air conditioning system comprising a refrigerant or of the invention, including each of Refrigerants 1-14, or heat transfer composition comprising a refrigerant of the present invention, including each of Heat Transfer Compositions 1-14. The present invention also provides a method of air conditioning using an air conditioning system, said method comprising the steps of (a) evaporating a refrigerant composition of the invention, including each of Refrigerants 1-14, in the vicinity of a fluid of body to be cooled, and (b) condensing said refrigerant. Air may be conditioned either directly or indirectly by the refrigerants of the invention, including each of Refrigerants 1-14. Examples of air conditioning systems include chillers, residential, industrial, commercial, and mobile air-conditioning including air conditioning of road vehicles such as automobiles, trucks and buses, as well as air conditioning of boats, and trains.

Preferred refrigeration systems of the present invention include chillers comprising a refrigerant of the present invention, including particularly each of Refrigerants 1-14.

Preferred refrigeration systems of the present invention include residential air-conditioning systems comprising a refrigerant of the present invention, including particularly each of Refrigerants 1-14.

Preferred refrigeration systems of the present invention include industrial air-conditioning systems comprising a refrigerant of the present invention, including particularly each of Refrigerants 1-14.

Preferred refrigeration systems of the present invention include commercial air-conditioning systems comprising a refrigerant of the present invention, including particularly each of Refrigerants 1-14

Preferred refrigeration systems of the present invention include mobile air-conditioning systems comprising a refrigerant of the present invention, including particularly each of Refrigerants 1-14.

It will be appreciated that any of the above refrigeration, air conditioning or heat pump systems using the refrigerant of the invention, including each of Refrigerants 1-14, or heat transfer compositions comprising a refrigerant of the present invention, including each of Heat Transfer Compositions 1-25, may comprise a suction line/liquid line heat exchanger (SL-LL HX).

Organic Rankine Cycle Systems

The refrigerant composition of the invention, including each of Refrigerants 1-14, or a heat transfer composition comprising a refrigerant of the present invention, including each of Heat Transfer Compositions, may be used in an organic Rankine cycle (ORC). In the context of ORC, the refrigerant used in these systems may also be categorized as the “working fluid”. Rankine cycle systems are known to be a simple and reliable means to convert heat energy into mechanical shaft power.

In industrial settings, it may be possible to use flammable working fluids such as toluene and pentane, particularly when the industrial setting has large quantities of flammables already on site in processes or storage. However, for instances where the risk associated with use of a flammable and/or toxic working fluid is not acceptable, such as power generation in populous areas or near buildings, it is necessary to use non-flammable and/or non-toxic refrigerants as the working fluid. There is also a drive in the industry for these materials to be environmentally acceptable in terms of GWP.

The process for recovering waste heat in an Organic Rankine cycle system involves pumping liquid-phase working-fluid through a heat exchanger (boiler) where an external (waste) heat source, such as a process stream, heats the working fluid causing it to evaporate into a saturated or superheated vapor. This vapor is expanded through a turbine wherein the waste heat energy is converted into mechanical energy. Subsequently, the vapor phase working fluid is condensed to a liquid and pumped back to the boiler in order to repeat the heat extraction cycle. Therefore, the invention relates to the use of a refrigerant of the invention, including each of Refrigerants 1-14, or a heat transfer compositions comprising a refrigerant of the present invention, including each of Heat Transfer Compositions 1-25, in an Organic Rankine Cycle.

Therefore, the invention provides a process for converting thermal energy to mechanical energy in a Rankine cycle, the method comprising the steps of i) vaporizing a working fluid with a heat source and expanding the resulting vapor, or vaporizing a working fluid with a heat source and expanding the resulting vapor, then ii) cooling the working fluid with a heat sink to condense the vapor, wherein the working fluid is a refrigerant or of the invention, including each of Refrigerants 1-14, or heat transfer compositions comprising a refrigerant of the present invention, including each of Heat Transfer Compositions. The mechanical work may be transmitted to an electrical device such as a generator to produce electrical power.

The heat source may be provided by a thermal energy source selected from industrial waste heat, solar energy, geothermal hot water, low pressure steam, distributed power generation equipment utilizing fuel cells, an internal combustion engine, or prime movers. Preferably, the low pressure steam is a low pressure geothermal steam or is provided by a fossil fuel powered electrical generating power plant.

It will be appreciated that the heat source temperatures can vary widely, for example from about 90° C. to >800° C., and can be dependent upon a myriad of factors including geography, time of year, etc. for certain combustion gases and some fuel cells. Systems based on sources such as waste water or low pressure steam from, e.g., a plastics manufacturing plants and/or from chemical or other industrial plant, petroleum refinery, and the like, as well as geothermal sources, may have source temperatures that are at or below about 100° C., and in some cases as low as about 90° C. or even as low as about 80° C. Gaseous sources of heat such as exhaust gas from combustion process or from any heat source where subsequent treatments to remove particulates and/or corrosive species result in low temperatures may also have source temperatures that are at or below about 130° C., at or below about 120° C., at or below about 100° C., at or below about 100° C., and in some cases as low as about 90° C. or even as low as about 80° C.

Electronic Cooling

The refrigerant compositions of the invention, including any one of Refrigerants 1 to 14, may be used in connection with systems and methods of electronic cooling, such as cooling of chips, electronic boards, batteries (including batteries used in cars, trucks, buses and other electronic transport vehicles), computers, and the like.

### EXAMPLES

In the examples which follow, the refrigerant compositions of interest are identified as compositions A1-A8 in Table 1 below. Each of the refrigerants A1-A8 was subjected to thermodynamic analysis to determine its ability to match the operating characteristics of R-134a in various refrigeration systems. The analysis was performed using experimental data collected for properties of various binary and ternary pairs of components used in the refrigerant. The composition of each pair was varied over a series of relative percentages in the experimental evaluation and the mixture parameters for each pair were regressed to the experimentally obtained data. Known vapor/liquid equilibrium behavior data available in the National Institute of Science and Technology (NIST) Reference Fluid Thermodynamic and Transport Properties Database software (Refprop 9.1 NIST Standard Database 23 from April 2016) were used for the Examples. The parameters selected for conducting the analysis were: same compressor displacement for all refrigerants, same operating conditions for all refrigerants, same compressor isentropic and volumetric efficiency for all refrigerants. In each Example, simulations were conducted using the measured vapor liquid equilibrium data. The simulation results are reported for each Example.

The refrigerant compositions identified in Table 1 below as Refrigerants A1, A2, A3, A4, A5, A6, A7 and A8 are non-flammable refrigerants within the broad scope of the present invention as described herein; however refrigerants A1, A2 and A8 are outside the scope of the most preferred embodiments since in the cases of A1 and A2 the evaporator glide of the refrigerant is not less than 3° C. and in the case of A8, the GWP of the refrigerant is not 150 or less.

TABLE 1
Glide and GWP criteria

| Re- | | R1336mzz | R1234ze | Evaporator | | |
|---|---|---|---|---|---|---|
| frigerant | R134a | (E) | (E) | Glide | | Capacity |
| No. | (wt %) | (wt %) | (wt %) | (° C.) | GWP | (% R134a) |
| A1 | 4.0% | 21.0% | 75.00% | 3.1 | 62.7 | 64% |
| A2 | 5.0% | 20.0% | 75.00% | 3.1 | 77.0 | 65% |
| A3 | 6.0% | 19.0% | 75.00% | 3.0 | 91.2 | 66% |
| A4 | 7.0% | 18.0% | 75.00% | 2.9 | 105.5 | 66% |
| A5 | 8.0% | 17.0% | 75.00% | 2.8 | 119.8 | 67% |
| A6 | 9.0% | 16.0% | 75.00% | 2.7 | 134.1 | 68% |
| A7 | 10.0% | 15.0% | 75.00% | 2.6 | 148.4 | 69% |
| A8 | 11.0% | 14.0% | 75.00% | 2.5 | 162.7 | 7071% |

### Example 1: Non-Flammable, Low GWP and Low Wide Compositions

Refrigerant A7 is considered by applicants to be a highly desirable refrigerant due to its excellent glide of about 2° C. while still maintaining a GWP of less than 150, and based on these results it was determined to examine refrigerant blends that have about 10% R-134a, as is the case with A7. In particular, the refrigerants labeled as B1-B11 in Table E1 below were formulated and studied on the basis of maintaining a level of R-134a of about 10% to determine such refrigerant blends that can be shown to be nonflammable.

TABLE E1
Non-flammable compositions with 10% of R134a

| Refrig- | R1234ze | R1336mzz | Evaporator | | | |
|---|---|---|---|---|---|---|
| erant | (E) | (E) | Glide | Flamma- | | Capacity |
| No. | (wt %) | (wt %) | (° C.) | bility | GWP | (% R134a) |
| B1 | 81.0% | 9.0% | 1.7 | Flammable | 148.8 | 72% |
| B2 | 80.0% | 10.0% | 1.9 | Flammable | 148.7 | 71% |
| B3 | 79.0% | 11.0% | 2.0 | Non | 148.6 | 71% |
| | | | | Flammable | | |
| B4 | 78.0% | 12.0% | 2.2 | Non | 148.6 | 70% |
| | | | | Flammable | | |
| B5 | 77.0% | 13.0% | 2.3 | Non | 148.5 | 70% |
| | | | | Flammable | | |
| B6 | 76.0% | 14.0% | 2.5 | Non | 148.5 | 69% |
| | | | | Flammable | | |
| B7 | 75.0% | 15.0% | 2.6 | Non | 148.4 | 69% |
| | | | | Flammable | | |
| B8 | 74.0% | 16.0% | 2.7 | Non | 148.3 | 68% |
| | | | | Flammable | | |
| B9 | 73.0% | 17.0% | 2.9 | Non | 148.3 | 68% |
| | | | | Flammable | | |
| B10 | 72.0% | 18.0% | 3.0 | Non | 148.2 | 67% |
| | | | | Flammable | | |
| B11 | 71.0% | 19.0% | 3.2 | Non | 148.2 | 67% |
| | | | | Flammable | | |

As can be seen from the results in Table E1, for blends that include about 10% by weight of R-134a, amounts of R-1234ze(E) of 80% or higher, and R-1336mzz(E) in amounts of 10% or lower (refrigerants B1 and B2) are flammable refrigerants, that is, are not Class 1 refrigerants. On the other hand, each of the refrigerants B3-B10 unexpectedly has the difficult-to-achieve combination of being nonflammable, having a glide 3° C. or below, and having a GWP of 150 or below. Thus, compositions of the present invention preferably comprise, consist essentially of, or consist of about 10% R134a, about 72% to about 79% R1234ze(E), and 11% to 18% R1336mzz(E), or preferably about 10% of R134a, 75% to about 79% R1234ze(E), and 11% to 15% R1336mzz(E).

### Example 2: Performance in Medium Temperature Refrigeration System with and without Suction Line (SL)/Liquid Line (LL) Heat Exchanger (HX)

Refrigerants B4, B7 and B9 were performance tested in a medium temperature refrigeration system with and without a suction line/liquid line heat exchanger (SL/LL HX). The analysis was carried out to assess the efficiency (COP) of Refrigerants B4, B7 and B9 in this system at different levels of effectiveness of the SL-LL HX under the conditions below.

Operating conditions were:
Condensing temperature=45° C.
Condensing Temperature—Ambient Temperature=10° C.
Condenser sub-cooling=0.0° C. (system with receiver)
Evaporating temperature=−8° C.,
Evaporator Superheat=5.5° C.
Compressor Isentropic Efficiency=65%
Volumetric Efficiency=100%
Temperature Rise in Suction Line=10° C.
Suction Line/Liquid Line Heat Exchanger Effectiveness: 0%, 35%, 55%, 75%

TABLE E2A
Performance in Medium-Temperature Refrigeration System with SL/LL HX

| | Efficiency @ | Efficiency @ | Efficiency @ | Efficiency @ |
|---|---|---|---|---|
| | 0% SL-LL HX | 35% SL-LL HX | 55% SL-LL HX | 75% SL-LL HX |
| Refrigerant | effectiveness | effectiveness | effectiveness | effectiveness |
| R134a | 100% | 100% | 100% | 100% |
| B4 | 99% | 100% | 101% | 101% |
| B7 | 99% | 100% | 101% | 102% |
| B9 | 99% | 100% | 101% | 102% |

TABLE E2B
Refrigeration Capacity in Medium-Temperature Refrigeration System with SL/LL HX

| | Capacity @ | Capacity @ | Capacity @ | Capacity @ |
|---|---|---|---|---|
| | 0% SL-LL HX | 35% SL-LL HX | 55% SL-LL HX | 75% SL-LL HX |
| Refrigerant | effectiveness | effectiveness | effectiveness | effectiveness |
| R134a | 100% | 100% | 100% | 100% |
| B4 | 69% | 70% | 71% | 71% |
| B7 | 68% | 69% | 70% | 70% |
| B9 | 67% | 68% | 69% | 69% |

Table E2A and Table E2B show the performance and refrigeration capacity of refrigerants in a medium temperature refrigeration system. It will be understood that the results under the column with “0%” efficiency for the SL-LL HX represent a system without a SL-LL HX, and that Refrigerants B7-B9 show improved performance in terms of efficiency (COP) than R134a when a SL/LL Heat Exchanger is employed.

### Example 3: Performance in Medium Temperature Refrigeration System with Two-Stage Vapor Injected Compression

Refrigerants B4, B7 and B9 were performance tested in a medium temperature refrigeration system with two stage injection compression. The analysis was carried out to assess the efficiency (COP) of Refrigerants B4, B7 and B9 in this system under the conditions below.

Operating conditions were:
Condensing temperature=45° C.
Condensing Temperature—Ambient Temperature=10° C.
Condenser sub-cooling=5.0° C.
Evaporating temperature=−8° C., Corresponding box temperature=1.7° C.
Evaporator Superheat=5.5° C.
Compressor Isentropic Efficiency=70%
Volumetric Efficiency=100%
Temperature Rise in Suction Line=10° C.
Vapor Injection Heat Exchanger (HX) Effectiveness: 15%, 35%, 55%, 75%

TABLE E3A
Performance in Medium-Temperature Refrigeration System with Two-Stage Compression with
Vapor Injection

| | Efficiency @ 15% | Efficiency @ 35% | Efficiency @ 55% | Efficiency @ 75% |
|---|---|---|---|---|
| | vapour injection | vapour injection | vapour injection | vapour injection |
| Refrigerant | HX effectiveness | HX effectiveness | HX effectiveness | HX effectiveness |
| R134a | 100% | 100% | 100% | 100% |
| B4 | 101% | 101% | 101% | 101% |
| B7 | 102% | 102% | 102% | 102% |
| B9 | 102% | 102% | 102% | 102% |

TABLE E3B
Refrigeration Capacity in Medium-Temperature Refrigeration System with Two-Stage Compression with
Vapor Injection

| | Capacity @ 15% | Capacity @ 35% | Capacity @ 55% | Capacity @ 75% |
|---|---|---|---|---|
| | vapour injection | vapour injection | vapour injection | vapour injection |
| Refrigerant | HX effectiveness | HX effectiveness | HX effectiveness | HX effectiveness |
| R134a | 100% | 100% | 100% | 100% |
| B4 | 74% | 74% | 74% | 74% |
| B7 | 73% | 73% | 73% | 73% |
| B9 | 72% | 72% | 72% | 72% |

Table E3A and Table E3B shows the performance and refrigeration capacity of refrigerants in a medium temperature refrigeration system. Compositions B4, B7 and B9 show improved performance in terms of efficiency (COP) than R134a in a two-stage compression with vapor injection.

### Example 4: Performance in CO₂ Cascade Refrigeration System

Cascade systems are generally used in applications where there is a large temperature difference (e.g. about 50-80° C., such as about 60-70° C.) between the ambient temperature and the box temperature (e.g. the difference in temperature between the air-side of the condenser in the high stage, and the air-side of the evaporator in the low stage). For example, a cascade system may be used for freezing products in a supermarket. In the following example, exemplary compositions of the invention were tested as the refrigerant in the high stage of a cascade refrigeration system. The refrigerant used in the low stage of the system was carbon dioxide.

Operating conditions were:
Condensing temperature=45° C.
High-stage Condensing Temperature—Ambient Temperature=10° C.
High-stage condenser sub-cooling=0.0° C. (system with receiver)
Evaporating temperature=−30° C., Corresponding box temperature=−18° C.
Low-stage Evaporator Superheat=3.3° C.
High-stage and Low-stage Compressor Isentropic Efficiency=65%
Volumetric Efficiency=100%
Temperature Rise in Suction Line Low Stage=15° C.
Temperature Rise in Suction Line High Stage=10° C.
Intermediate Heat Exchanger CO₂ Condensing Temperature=OC, 5° C. and 10° C.
Intermediate Heat Exchanger Superheat=3.3° C.
Difference in Temperature in Intermediate Heat Exchanger=8° C.

TABLE E4A
Performance in CO2 Cascade Refrigeration System

| | Efficiency @ | Efficiency @ | Efficiency @ |
|---|---|---|---|
| Refrigerant | Tcond = 0° C. | Tcond = 5° C. | Tcond = 10° C. |
| R134a | 100% | 100% | 100% |
| B4 | 99% | 100% | 100% |
| B7 | 99% | 100% | 100% |
| B9 | 99% | 100% | 100% |

TABLE E4B
Refrigeration Capacity in CO2 Cascade Refrigeration System

| | Capacity @ | Capacity @ | Capacity @ |
|---|---|---|---|
| Refrigerant | Tcond = 0° C. | Tcond = 5° C. | Tcond = 10° C. |
| R134a | 100% | 100% | 100% |
| B4 | 69% | 70% | 71% |
| B7 | 68% | 69% | 70% |
| B9 | 67% | 68% | 69% |

Table E4A and Table E4B show the performance and refrigeration capacity of refrigerants in the high stage of a cascade refrigeration system. Refrigerants B4, B7 and B9 match the efficiency of R134a for different condensing temperatures of low stage cycle.

### Example 5: Performance in Low Temperature Refrigeration System with and without Suction Line/Liquid Line Heat Exchanger

Refrigerants B4, B7 and B9 were performance tested in a low temperature refrigeration system with and without a suction line/liquid line heat exchanger (SL/LL HX). The analysis was carried out to assess the efficiency (COP) of Refrigerants B4, B7 and B9 in this system at different levels of effectiveness of the SL-LL HX under the conditions below.

Operating conditions were:
Condensing temperature=45° C.
Condensing Temperature—Ambient Temperature=10° C.
Condenser sub-cooling=0.0° C. (system with receiver)
Evaporating temperature=−35° C., Corresponding box temperature=−25° C.
Evaporator Superheat=5.5° C.
Compressor Isentropic Efficiency=65%
Volumetric Efficiency=100%
Temperature Rise in Suction Line=10° C.
Suction Line/Liquid Line Heat Exchanger Effectiveness: 0%, 35%, 55%, 75%

TABLE E5A
Performance in Low-Temperature Refrigeration System with SL/LL HX

| | Efficiency @ | Efficiency @ | Efficiency @ | Efficiency @ |
|---|---|---|---|---|
| | 0% SL-LL HX | 35% SL-LL HX | 55% SL-LL HX | 75% SL-LL HX |
| Refrigerant | effectiveness | effectiveness | effectiveness | effectiveness |
| R134a | 100% | 100% | 100% | 100% |
| B4 | 96% | 99% | 100% | 101% |
| B7 | 96% | 99% | 100% | 101% |
| B9 | 96% | 99% | 100% | 101% |

TABLE E5B
Refrigeration Capacity in Low-Temperature Refrigeration System with SL/LL HX

| | Capacity @ | Capacity @ | Capacity @ | Capacity @ |
|---|---|---|---|---|
| | 0% SL-LL HX | 35% SL-LL HX | 55% SL-LL HX | 75% SL-LL HX |
| Refrigerant | effectiveness | effectiveness | effectiveness | effectiveness |
| R134a | 100% | 100% | 100% | 100% |
| B4 | 63% | 66% | 67% | 68% |
| B7 | 62% | 64% | 65% | 66% |
| B9 | 61% | 63% | 64% | 65% |

Table E5A and Table E5B show the performance and refrigeration capacity of refrigerants in a low temperature refrigeration system. It will be understood that the results under the column with “0%” efficiency for the SL-LL HX represent a system without a SL-LL HX, and that Refrigerants B7-B9 show improved performance in terms of efficiency (COP) than R134a when a SL/LL Heat Exchanger is employed.

### Example 6: Performance in Vending Machines with Suction Line/Liquid Line Heat Exchanger

Refrigerants B4, B7 and B9 were performance tested in a vending machine refrigeration system with and without a suction line/liquid line heat exchanger (SL/LL HX). The analysis was carried out to assess the efficiency (COP) of Refrigerants B4, B7 and B9 in this system at different levels of effectiveness of the SL-LL HX under the conditions below.

Operating Conditions:
Condensing temperature=45° C.
Condensing Temperature—Ambient Temperature=10° C.
Condenser sub-cooling=5.5° C.
Evaporating temperature=−8° C.,
Evaporator Superheat=3.5° C.
Compressor Isentropic Efficiency=60%
Volumetric Efficiency=100%
Temperature Rise in Suction Line=5° C.
Suction Line/Liquid Line Heat Exchanger Effectiveness: 0%, 35%, 55%, 75%

TABLE E6A
Performance in Vending Machine with SL/LL HX

| | Efficiency @ | Efficiency @ | Efficiency @ | Efficiency @ |
|---|---|---|---|---|
| | 0% SL-LL HX | 35% SL-LL HX | 55% SL-LL HX | 75% SL-LL HX |
| Refrigerant | effectiveness | effectiveness | effectiveness | effectiveness |
| R134a | 100% | 100% | 100% | 100% |
| B4 | 99% | 101% | 101% | 102% |
| B7 | 99% | 101% | 101% | 102% |
| B9 | 99% | 101% | 101% | 102% |

TABLE E6B
Refrigeration Capacity in Vending Machine with SL/LL HX

| | Capacity | Capacity | Capacity | Capacity |
|---|---|---|---|---|
| | @0% | @35% | @55% | @75% |
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| B4 | 69% | 70% | 71% | 71% |
| B7 | 68% | 69% | 70% | 70% |
| B9 | 67% | 68% | 69% | 69% |

Table E6A and Table E6B shows performance and refrigeration capacity of refrigerants in a vending machine system with and without SL/LL HX. It will be understood that the results under the column with “0%” efficiency for the SL-LL HX represent a system without a SL-LL HX, and that Refrigerants B4, B7 and B9 show improved performance in terms of efficiency (COP) compared to R134a when a SL/LL Heat Exchanger is employed.

### Example 7: Performance in Air-Source Heat Pump Water Heaters

Refrigerants B4, B7 and B9 were performance tested in an air source heat pump water heater system. The analysis was carried out to assess the efficiency (COP) of Refrigerants B7-B9 in this system under the conditions below.

Operating conditions were:
Condensing temperature=55° C.
Water Inlet Temperature=45° C., Water Outlet Temperature=50° C.
Condenser sub-cooling=5.0° C.
Evaporating temperature=−5° C., Corresponding ambient temperature=10° C.
Evaporator Superheat=3.5° C.
Compressor Isentropic Efficiency=65%
Volumetric Efficiency=100%
Temperature Rise in Suction Line=5° C.
Suction Line/Liquid Line Heat Exchanger Effectiveness: 0%, 35%, 55%, 75%

TABLE E7
Performance, Heating Capacity and Compressor Discharge
Temperature in Heat Pump Water Heaters

| | | Heating | Comp. Discharge |
|---|---|---|---|
| Refrigerant | Efficiency | Capacity | Temp (° C.) |
| R134a | 100% | 100% | 88.0 |
| B4 | 99% | 70% | 78.6 |
| B7 | 99% | 69% | 78.5 |
| B9 | 99% | 67% | 78.5 |

Table E7 shows performance, heating capacity and compressor discharge temperature of refrigerants in a heat pump water heater. Refrigerants B4, B7 and B9 show efficiency similar to R134a. Refrigerants B4, B7 and B9 show lower discharge temperature than R134a, indicating better reliability for the compressor.

### Example 8: Performance in Air-Source Heat Pump Water Heaters with Suction Line/Liquid Line Heat Exchanger

Refrigerants B4, B7 and B9 were performance tested in an air source heat pump water heater system with and without a suction line/liquid line heat exchanger (SL/LL HX). The analysis was carried out to assess the efficiency (COP) of Refrigerants B7-B9 in this system at different levels of effectiveness of the SL-LL HX under the conditions below.

Operating conditions were:
Condensing temperature=55° C.
Water Inlet Temperature=45° C., Water Outlet Temperature=50° C.
Condenser sub-cooling=5.0° C.
Evaporating temperature=−5° C., Corresponding ambient temperature=10° C.
Evaporator Superheat=3.5° C.
Compressor Isentropic Efficiency=65%
Volumetric Efficiency=100%
Temperature Rise in Suction Line=5° C.
Suction Line/Liquid Line Heat Exchanger Effectiveness: 0%, 35%, 55%, 75%

TABLE E8A
Performance and Compressor Discharge Temperature in Heat
Pump Water Heaters with SL/LL HX

| | SL-LL HX Eff. | | SL-LL HX Eff. | | SL-LL HX Eff. | |
|---|---|---|---|---|---|---|
| | 35% | | 55% | | 75% | |
| | | Comp. | | Comp. | | Comp. |
| | | Dis- | | Dis- | | Dis- |
| | | charge | | charge | | charge |
| Re- | | Temp | | Temp | | Temp |
| frigerant | Efficiency | (° C.) | Efficiency | (° C.) | Efficiency | (° C.) |
| R134a | 100% | 105.5 | 100% | 115.5 | 100% | 125.3 |
| B4 | 101% | 95.2 | 101% | 104.6 | 102% | 113.9 |
| B7 | 101% | 95.0 | 101% | 104.3 | 102% | 113.6 |
| B9 | 101% | 94.8 | 101% | 104.1 | 102% | 113.2 |

TABLE E8B
Heating Capacity in Heat Pump Water Heaters with SL/LL HX

| | Heating capacity | | |
|---|---|---|---|
| | SL-LL HX | SL-LL HX | SL-LL HX |
| Refrigerant | Eff. 35% | Eff. 55% | Eff. 75% |
| R134a | 100% | 100% | 100% |
| B4 | 71% | 71% | 71% |
| B7 | 70% | 70% | 70% |
| B9 | 68% | 69% | 69% |

Table E8A shows performance and compressor discharge temperature of refrigerants in a heat pump water heater with SL/LL HX. While Table E8B shows the heating capacity. Refrigerants B4, B7 and B9 show higher efficiency than R134a when a SL/LL Heat Exchanger is employed. Refrigerants B4, B7 and B9 show lower discharge temperature than R134a, indicating better reliability for the compressor.

### Example 9: Performance in Mobile Air Conditioning Systems (Buses, Trains, Cars)

Refrigerants B4, B7 and B9 were performance tested in a mobile air conditioning system under various condenser temperature conditions. The analysis was carried out to assess the efficiency (COP) of Refrigerants B4, B7 and B9 in this system under the conditions below

Operating Conditions:
Condensing temperature=45° C. to 75° C.
Condenser sub-cooling=5.0° C.
Evaporating temperature=4° C., corresponding indoor room temperature=35° C.
Evaporator Superheat=5.0° C.
Compressor Isentropic Efficiency=65%
Volumetric Efficiency=100%
Temperature Rise in Suction Line=0° C.

TABLE E9A
Performance in Mobile AC systems

| | Condensing | Condensing | Condensing | Condensing |
|---|---|---|---|---|
| | 45° C. | 55° C. | 65° C. | 75° C. |
| Refrigerant | Efficiency | Efficiency | Efficiency | Efficiency |
| R134a | 100% | 100% | 100% | 100% |
| B4 | 100% | 100% | 99% | 99% |
| B7 | 100% | 100% | 99% | 99% |
| B9 | 100% | 100% | 99% | 99% |

TABLE E9B
Cooling Capacity in Mobile AC systems

| | Cooling Capacity | | | |
|---|---|---|---|---|
| | Condensing | Condensing | Condensing | Condensing |
| Refrigerant | 45° C. | 55° C. | 65° C. | 75° C. |
| R134a | 100% | 100% | 100% | 100% |
| B4 | 71% | 71% | 70% | 69% |
| B7 | 70% | 70% | 69% | 68% |
| B9 | 69% | 69% | 68% | 67% |

Table E9A and Table E9B show performance and cooling capacity of refrigerants in a Mobile AC system. In Table E9B, Refrigerants B4, B7 and B9 show efficiency similar to R134a over a range of condensing temperatures which correspond to different ambient temperatures.

### Example 10: Micro-Cascade Refrigeration System

A micro-cascade system combines a traditional medium temperature DX refrigeration system, with or without suction line liquid line heat exchanger (SLHX), which operates with the fluid inventions, a low temperature cascade refrigeration in which the upper state uses the fluid inventions and is connected to several small low temperature stages, in the form of self-contained systems, using fluids such as but not limited to CO₂, R1234yf, and R455A. As used herein, the term “medium temperature DX refrigeration system” refers to a medium temperature system in which the evaporator is a dry evaporator.

A useful micro-cascade system is disclosed in our pending U.S. Ser. No. 16/014,863 filed Jun. 21, 2018 and U.S. Ser. No. 16/015,145 filed Jun. 21, 2018, claiming priority to U.S. Ser. 62/522,386 filed Jun. 21, 2017, U.S. Ser. 62/522,846 filed Jun. 21, 2017, 62/522,851 filed Jun. 21, 2017, and Ser. 62/522,860 filed Jun. 21, 2017, all incorporated herein by reference in their entireties. Operating conditions:

Baseline R404A combined MT and LT system
Refrigeration Capacity
   Low Temperature: 33,000 W
   Medium Temperature: 67,000 W
Volumetric efficiency: 95% for both MT ad LT
Compressor Isentropic efficiency
   Medium Temperature=70% and Low Temperature=67%
Condensing temperature: 105° F.
Medium Temperature evaporation temperature: 20° F.
Low Temperature evaporation temperature: −20° F.
Evaporator superheat: 10° F. (both Medium and Low Temperature)
Suction line temperature rise (due to heat transfer to surroundings)
   Baseline: Medium Temperature: 25° F.; Low Temperature: 50° F.
   Cascade/self-contained without SLHX: Medium Temperature: 10° F.; Low Temperature: 25° F.
   Cascade/self-contained with SLHX: Medium Temperature: 10° F.; Low Temperature: 15° F.
SLHX efficiency when used: 65%

TABLE E10
Comparison between R404A and the micro-cascade system

| | High stage (medium | Low stage (Low | Relative COP % |
|---|---|---|---|
| Systems | temperature) | temperature) | of R404A |
| R404A | R404A | | 100% |
| Cascade with | B4 | R1234yf | 125% |
| R1234yf | B7 | R1234yf | 125% |
| | B9 | R1234yf | 125% |
| Cascade with | B4 | R455A | 125% |
| R455A | B7 | R455A | 125% |
| | B9 | R455A | 125% |

Table E10 shows that the micro-cascade system has about 125% higher COP than a baseline medium temperature DX system with R404A.

### Example 11: Non-Flammable Secondary Refrigerants with Pressure Above Atmospheric Pressure

The inventive refrigerants, including each of Refrigerants B4, B7 and B9, or heat transfer compositions comprising a refrigerant of the present invention, including each of Refrigerants B4, B7 and B9, can work as secondary fluids. The refrigerants of the invention, including each of Refrigerants B4, B7 and B9, have the necessary properties to ensure that the operating pressure of the refrigerant is not below atmospheric pressure at the given evaporator temperature, so that air would not enter the system and at the same time it is low enough to prevent significant leaks.
Table E11 shows the pressure of refrigerants for evaporating temperatures ranging from −5° C. to 10° C. which cover the various operating conditions for air conditioning applications.
It can be observed from the table that all refrigerants maintain pressure higher than atmospheric pressure.
The primary refrigerant used in the vapor compression loop may be selected from the group consisting of R404A, R507, R410A, R455A, R32, R466A, R44B, R290, R717, R452B, R448A, R1234ze(E), R1234yf and R449A.
The temperature of the air/body to be cooled—about 25° C. to about 0° C.

TABLE E11
Secondary Fluids

| Secondary | Evaporator | Evaporator |
|---|---|---|
| Refrigerant | Temperature (° C.) | Pressure (bar) |
| B4 | −5 | 1.7 |
| | 0 | 2.0 |
| | 10 | 2.9 |
| B7 | −5 | 1.7 |
| | 0 | 2.0 |
| | 10 | 2.9 |
| B9 | −5 | 1.6 |
| | 0 | 2.0 |
| | 10 | 2.8 |

### Example 12: Performance in Stationary Air Conditioning Systems

Refrigerants B4, B7 and B9 were performance tested in a stationary air conditioning system under various condenser temperature conditions. The analysis was carried out to assess the efficiency (COP) of Refrigerants B4, B7 and B9 in this system under the conditions below.

Operating Conditions:
Condensing temperature=45° C. to 65° C.
Condenser sub-cooling=5.0° C.
Evaporating temperature=10° C., corresponding indoor room temperature=35° C.
Evaporator Superheat=5.0° C.
Compressor Isentropic Efficiency=72%
Volumetric Efficiency=100%

TABLE E12A
Performance in Stationary AC systems

| | Condensing | Condensing | Condensing |
|---|---|---|---|
| | 45° C. | 55° C. | 65° C. |
| Refrigerant | Efficiency | Efficiency | Efficiency |
| R134a | 100% | 100% | 100% |
| B4 | 100% | 100% | 100% |
| B7 | 100% | 100% | 100% |
| B9 | 100% | 100% | 100% |

TABLE E12B
Cooling Capacity in Stationary AC systems

| | Cooling Capacity | | |
|---|---|---|---|
| | Condensing | Condensing | Condensing |
| Refrigerant | 45° C. | 55° C. | 65° C. |
| R134a | 100% | 100% | 100% |
| B4 | 72% | 72% | 71% |
| B7 | 71% | 71% | 70% |
| B9 | 71% | 70% | 69% |

Refrigerants B4, B7 and B9 show efficiency similar to R134a over range of condensing temperatures which correspond to different ambient temperatures.

### Example 13: Performance in Commercial Air Conditioning Systems

Refrigerants B4, B7 and B9 were performance tested in a commercial air conditioning system under various condenser temperature conditions. The analysis was carried out to assess the efficiency (COP) of Refrigerants B4, B7 and B9 in this system under the conditions below.

Operating Conditions:
Condensing temperature=45° C. to 65° C.
Evaporating temperature=10° C.,
Evaporator Superheat=5.0° C.
Compressor Isentropic Efficiency=72%
Volumetric Efficiency=100%

TABLE E13A
Performance in Commercial AC systems

| | Condensing | Condensing | Condensing |
|---|---|---|---|
| | 45° C. | 55° C. | 65° C. |
| Refrigerant | Efficiency | Efficiency | Efficiency |
| R134a | 100% | 100% | 100% |
| B4 | 100% | 100% | 100% |
| B7 | 100% | 100% | 100% |
| B9 | 100% | 100% | 100% |

TABLE E13B
Cooling Capacity in Commercial AC systems

| | Cooling Capacity | | |
|---|---|---|---|
| | Condensing | Condensing | Condensing |
| Refrigerant | 45° C. | 55° C. | 65° C. |
| R134a | 100% | 100% | 100% |
| B4 | 72% | 72% | 71% |
| B7 | 71% | 71% | 70% |
| B9 | 71% | 70% | 69% |

Refrigerants B4, B7 and B9 show efficiency similar to R134a over range of condensing temperatures which correspond to different ambient temperatures.

### Example 14: Performance in Transport (Refrigerated Trucks, Containers) Medium Temperature Refrigeration Applications with and without Suction Line (SL)/Liquid Line (LL) Heat Exchanger (HX)

Refrigerants B4, B7 and B9 were performance tested in a transport refrigeration system with and without a suction line/liquid line heat exchanger (SL/LL HX) at medium temperature refrigeration conditions. The analysis was carried out to assess the efficiency (COP) of Refrigerants B4, B7 and B9 in this system at different levels of effectiveness of the SL-LL HX under the conditions below.

Operating conditions were:
Condensing temperature=45° C.
Condensing Temperature—Ambient Temperature=10° C.
Condenser sub-cooling=0.0° C. (system with receiver)
Evaporating temperature=−8° C.,
Evaporator Superheat=5.5° C.
Compressor Isentropic Efficiency=65%
Volumetric Efficiency=100%
Temperature Rise in Suction Line=15° C.
Suction Line/Liquid Line Heat Exchanger Effectiveness: 0%, 35%, 55%, 75%

TABLE E14A
Performance in Medium-Temperature Transport
Refrigeration System with SL/LL HX

| | Efficiency | Efficiency | Efficiency | Efficiency |
|---|---|---|---|---|
| | @0% | @35% | @55% | @75% |
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| B4 | 99% | 100% | 101% | 101% |
| B7 | 99% | 100% | 101% | 102% |
| B9 | 99% | 100% | 101% | 102% |

TABLE 14B
Refrigeration Capacity in Medium-Temperature
Transport Refrigeration System with SL/LL HX

| | Capacity | Capacity | Capacity | Capacity |
|---|---|---|---|---|
| | @0% | @35% | @55% | @75% |
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| B4 | 69% | 70% | 71% | 71% |
| B7 | 68% | 69% | 70% | 70% |
| B9 | 67% | 68% | 69% | 69% |

Table E14A and Table E14B shows the performance and refrigeration capacity of Refrigerants B4, B7 and B9 in a medium temperature transport refrigeration system. It will be understood that the results under the column with “0%” efficiency for the SL-LL HX represent a system without a SL-LL HX, and that Refrigerants B4, B7 and B9 show improved performance in terms of efficiency (COP) than R134a when a SL/LL Heat Exchanger is employed.

### Example 15: Performance in Transport (Refrigerated Trucks, Containers) Low Temperature Refrigeration Applications with and without Suction Line/Liquid Line Heat Exchanger

Refrigerants B4, B7 and B9 were performance tested in a transport refrigeration system with and without a suction line/liquid line heat exchanger (SL/LL HX) at low temperature refrigeration conditions. The analysis was carried out to assess the efficiency (COP) of Refrigerants B4, B7 and B9 in this system at different levels of effectiveness of the SL-LL HX under the conditions below.

Operating conditions were:
Condensing temperature=45° C.
Condensing Temperature—Ambient Temperature=10° C.
Condenser sub-cooling=0.0° C. (system with receiver)
Evaporating temperature=−35° C., Corresponding box temperature=−25° C.
Evaporator Superheat=5.5° C.
Compressor Isentropic Efficiency=65%
Volumetric Efficiency=100%
Temperature Rise in Suction Line=15° C.
Suction Line/Liquid Line Heat Exchanger Effectiveness: 0%, 35%, 55%, 75%

TABLE E15A
Performance in Low-Temperature Transport Refrigeration
System with SL/LL HX

| | Efficiency | Efficiency | Efficiency | Efficiency |
|---|---|---|---|---|
| | @0% | @35% | @55% | @75% |
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| B4 | 96% | 99% | 100% | 101% |
| B7 | 96% | 99% | 100% | 101% |
| B9 | 96% | 99% | 100% | 101% |

TABLE E15B
Refrigeration Capacity in Low-Temperature Transport
Refrigeration System with SL/LL HX

| | Efficiency | Efficiency | Efficiency | Efficiency |
|---|---|---|---|---|
| | @0% | @35% | @55% | @75% |
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| B4 | 63% | 66% | 67% | 68% |
| B7 | 62% | 64% | 65% | 66% |
| B9 | 61% | 63% | 64% | 65% |

Table E15A and Table E15B shows the performance and refrigeration capacity of Refrigerants B4, B7 and B9 in a low temperature transport refrigeration system. It will be understood that the results under the column with “0%” efficiency for the SL-LL HX represent a system without a SL-LL HX, and that Refrigerants B4, B7 and B9 show improved performance in terms of efficiency (COP) than R134a when a SL/LL Heat Exchanger is employed.

### Example 16: Electronic Cooling

Refrigerants B4, B7 and B9 are performance tested to evaluate cooling of electronic equipment (including in the cooling of chips, electronic boards, batteries (including batteries used in cars, trucks, buses and other electronic transport vehicles), computers, and the like), including in the form of a heat pipe, a thermosiphon and the like, as well as vapor compression cooling. The analysis is carried out to assess the performance of Refrigerants B4, B7 and B9 in these applications. Refrigerants B4, B7 and B9 show performance similar to R134a.

What is claimed is:

1. A refrigerant consisting essentially of:
(a) from about 75% to about 80% by weight of HFO-1234ze(E);
(b) from 6% to less than 11% by weight of HFC-134a; and
(c) from 11% to about 17% by weight of HFO-1336mzz (E).

2. The refrigerant of claim 1 consisting essentially of:
(a) from about 75% to less than 79% by weight of HFO-1234ze(E);
(b) from 6% to not greater than 10% by weight of HFC-134a; and
(c) from about 11% to about 15% by weight of HFO-1336mzz (E).

3. The refrigerant of claim 1 consisting essentially of:
(a) from 75% to 78% by weight of HFO-1234ze(E);
(b) from 8% to less than 11% by weight of HFC-134a; and
(c) from 11% to about 17% by weight of HFO-1336mzz (E).

4. The refrigerant of claim 3 consisting essentially of:
(a) about 78% by weight of HFO-1234ze (E),
(b) 10%+2.0%/−0.5% by weight of HFC-134a; and
(c) about 12% by weight of HFO-1336mzz (E).

5. A refrigerant consisting of:
(a) from 75% to less than 79% by weight of HFO-1234ze(E);
(b) from 8% to not greater than 12% by weight of HFC-134a; and
(c) from 11% to about 15% by weight of HFO-1336mzz (E).

6. The refrigerant of claim 5 consisting of:
(a) about 77% by weight of HFO-1234ze (E),
(b) 10%+2.0%/−0.5% by weight of HFC-134a; and
(c) about 13% by weight of HFO-1336mzz (E).

7. The refrigerant of claim 5 consisting of:
(a) 78%+0.5%/−2.0% by weight of HFO-1234ze (E),
(b) 10%+2.0%/−0.5% by weight of HFC-134a; and
(c) 12%+2.0%/−0.5% by weight of HFO-1336mzz (E).

8. The refrigerant of claim 5 consisting of:
(a) 78% by weight of HFO-1234ze (E),
(b) 10% by weight of HFC-134a; and
(c) 12% by weight of HFO-1336mzz (E).

9. A refrigerant comprising at least about 98.5% by weight of the following three components in the following relative amounts based on the three listed components:
(a) from about 75% to about 80% by weight of HFO-1234ze(E);
(b) from 6% to less than 11% by weight of HFC-134a; and
(c) from 11% to about 17% by weight of HFO-1336mzz (E),
wherein said refrigerant is a Class 1A refrigerant.

10. The refrigerant of claim 9 wherein said refrigerant has an evaporator glide of less than 3° C. and a GWP of less than 150.

11. A heat transfer composition comprising the refrigerant of claim 7 and at least one lubricant.

12. The heat transfer composition of claim 11 wherein said at least one lubricant is selected from POE and PVE.

13. The heat transfer composition of claim 11 wherein said at least one lubricant comprises POE.

14. The heat transfer composition of claim 11 wherein said at least one lubricant comprises PVE.

15. A heat transfer composition comprising a refrigerant according to claim 7.

16. A heat transfer system comprising a heat transfer composition according to claim 15.

17. A heat transfer system comprising a compressor, and evaporator and a condenser and containing a refrigerant claim 15.

18. A heat transfer system comprising a compressor, and evaporator and a condenser and containing a heat transfer composition according to claim 15.

19. A heat transfer system according to claim 18 wherein said heat transfer system comprises one or more of an electronic cooling system, low temperature refrigeration, medium temperature refrigeration, cascade refrigeration, transport refrigeration, secondary loop systems, air conditioning, heat pumps and ORC.

20. A heat transfer system according to claim 18 wherein said heat transfer system is an electronic cooling system, low temperature refrigeration system, medium temperature refrigeration system, transport refrigeration system, heat pump or cascade refrigeration.
